(19) United States
(12) Patent Application Publication
(10) Pub. No.: US 2023/0017073 A1
(43) Pub. Date: Jan. 19, 2023

(54) SYSTEM AND METHOD FOR TREATING WOOD

(71) Applicant: Mitch Lampe, St. Paul, MN (US)

(72) Inventor: Mitch Lampe, St. Paul, MN (US)

(21) Appl. No.: 17/866,763

(22) Filed: Jul. 18, 2022

Related U.S. Application Data
(60) Provisional application No. 63/223,140, filed on Jul. 19, 2021.

(51) Int. Cl. B27M 1/06; B44B 5/00

(52) U.S. Cl. CPC B27M 1/06; B44B 5/0047

(57) ABSTRACT

A system and method for treating wood material is provided. The method comprising: applying heat to the wood thereby charring the surface of the wood; applying pressure to the wood with a press having a pattern, thereby forming a charred surface with a pattern; cooling the wood with water or other coolant; letting the wood dry; brushing the charred surface of the wood; and applying a sealant to the surface of the wood. The system comprising a heating system for charring the surface of the wood, a mechanical press for forming a pattern on the charred surface, and a cooling system for cooling the wood. The system and method used to produce decorative wood pieces with a charred surface and a pattern pressed into it.

### CROSS-REFERENCE TO RELATED APPLICATIONS

The present application claims priority to U.S. Provisional Application 63/223,140, titled SYSTEM AND METHOD FOR TREATING WOOD, and filed on Jul. 19, 2021, the entirety of which is hereby incorporated by reference herein, including any figures, tables, drawings, or other information.

### FIELD OF THE DISCLOSURE

This disclosure relates to treatments for preservation of a wood material. More specifically and without limitation, this disclosure relates to heat treatment of wood materials.

### OVERVIEW OF THE DISCLOSURE

Methods for treating wood are old in the art and date back to the time of antiquities. Some methods are directed to producing a wood having a high aesthetic appeal, such as staining, painting or the like. Some other methods are directed toward preservation of wood. However, many of these methods are expensive and time consuming.

One conventional process for treating wood, referred to as pressure treating, immerses wood in a liquid chemical preservative within a pressure chamber. The chamber is sealed and pressure and/or vacuum is applied to force the preservative into the fiber of the wood. While pressure treating wood effectively reduces vulnerability to insects and rot, pressure treated wood may have a high moisture content and may take several weeks or even months to dry or require drying in a kiln. Before pressure treated wood material is fully dried, excess moisture in the wood material may prevent the wood material from being painted or stained by a worker. For example, moisture content of recently pressure treated wood may prevent the wood from absorbing stain. Moisture content may additionally cause paint to peal after it is applied. Pressure treatment of wood is also a slow, inefficient process. Pressure treatment processes inherently require wood to be treated in batches, which can take 6 or more hours for each batch. Additionally, many customers are weary of possible exposure to chemicals used in pressure treatment of wood.

As such, there is a need for a new method of treating wood as well as a need for new methods of manufacturing items made from the treated wood. There is a long felt but unsolved need for improved systems and methods for treating wood. Therefore, for all the reasons stated above, and the reasons stated below, there is a need in the art for a wood treatment system and method that improve upon the state of the art.

Thus, it is an object of the disclosure to provide a system and method for treatment of wood that quickly and effectively treats wood.

Another object of the disclosure is to provide a system and method for treatment of wood that cures and increases longevity of wood.

Yet another object of the disclosure is to provide a system and method for treatment of wood that controls cracking.

Another object of the disclosure is to provide a system and method for treatment of wood that does not require a lengthy drying time.

Yet another object of the disclosure is to provide a system and method for treatment of wood that is streamlined.

Another object of the disclosure is to provide a system and method for treatment of wood that can be implemented in a production line.

Yet another object of the disclosure is to provide a system and method for treatment of wood that is easy to control.

Another object of the disclosure is to provide a system and method for treatment of wood that is relatively inexpensive.

Yet another object of the disclosure is to provide a system and method for treatment of wood that does not use chemicals.

Another object of the disclosure is to provide a system and method for treatment of wood that is easy to use.

Yet another object of the disclosure is to provide a system for treatment of wood that has a long useful life.

Another object of the disclosure is to provide a system for treatment of wood that is durable.

Yet another object of the disclosure is to provide a system for treatment of wood that has a robust design.

Another object of the disclosure is to provide a system for treatment of wood that is easy to install.

Yet another object of the disclosure is to provide a system for treatment of wood that increases design options

Another object of the disclosure is to provide a system for treatment of wood that is high quality.

These and other objects, features, or advantages of the disclosure will become apparent from the specification, figures, and claims.

### SUMMARY OF THE DISCLOSURE

In one or more arrangements, a system is presented for treating wood material. The system includes a heating system configured to apply heat to the wood material and a mechanical press configured to apply pressure to the wood material after heating by the heating system.

In one or more arrangements, the system includes a conveyor configured to transport the wood material from a source end of the conveyor to a destination end of the conveyor. The heating system is operably connected to the conveyer and is configured to apply the heat to the wood material as it is transported from the source end to the destination end. The mechanical press is operably connected to the conveyer and is configured to apply the pressure to the wood material as it is transported from the source end to the destination end after heat is applied by the heating system. In one or more arrangements, conveyor is a roller type conveyor configured to transport the wood material on a set of rollers from a source end to a destination end.

In one or more arrangements, the mechanical press is configured to form a pattern on the wood material. In one or more arrangements, the mechanical press is a roller having a pattern formed on an exterior surface of the roller. In one or more arrangements, the pattern is formed by protrusions on the exterior surface of the roller. In one or more arrangements, the pattern is formed by recesses on the exterior surface of the roller. In one or more arrangements, the pattern is uniform. In one or more arrangements the pattern is non-uniform.

In one or more arrangements, the system includes a cooling system configured to cool the wood material after applying heat and pressure. In one or more arrangements, the cooling system includes a sprayer configured to apply water and/or coolant to the wood material after pressure is applied to the wood material by the mechanical press.

In one or more arrangements, the heating system is a torch. In one or more arrangements, the heating system is an electric heating element. In one or more arrangements, the heating system is a radiant heating element. In one or more arrangements, the heating system is configured to apply heat directly to the wood material. In one or more arrangements, the heating system is configured to apply heat indirectly to the wood material. In one or more arrangements, the heating system is configured to apply heat in a range of 400,000-600,000 BTU.

### BRIEF DESCRIPTION OF THE DRAWINGS

FIG. 1 shows a diagram of a method for treating wood, the diagram showing the steps of: preparing the wood; applying heat treatment to the wood; pressing the heated wood; cooling the wood; and applying a sealant (such as polyurethane finish) or liquid treatment, or performing other post treatment processing to the wood.

FIG. 2 is a front view of the system for treating wood; the view showing a conveyor with a frame with legs, they conveyor extending from a source end to a destination end; a heating system formed of a torch or torches; a mechanical press; and a cooling system formed of a sprayer near the destination end.

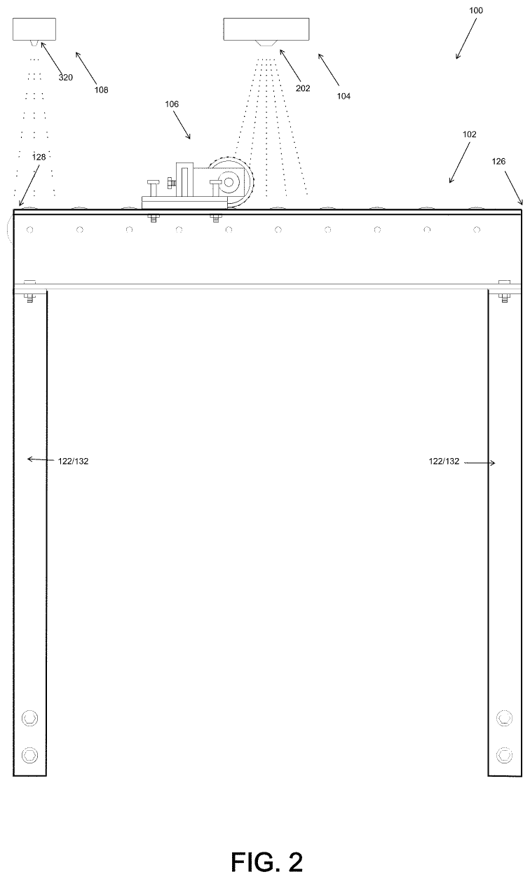

FIG. 3 is a rear view of the system for treating wood, the view showing a conveyor with a frame with legs and siderails, the conveyor extending from a source end to a destination end; a heating system formed of a torch or torches; a mechanical press; and a cooling system formed of a sprayer near the destination end.

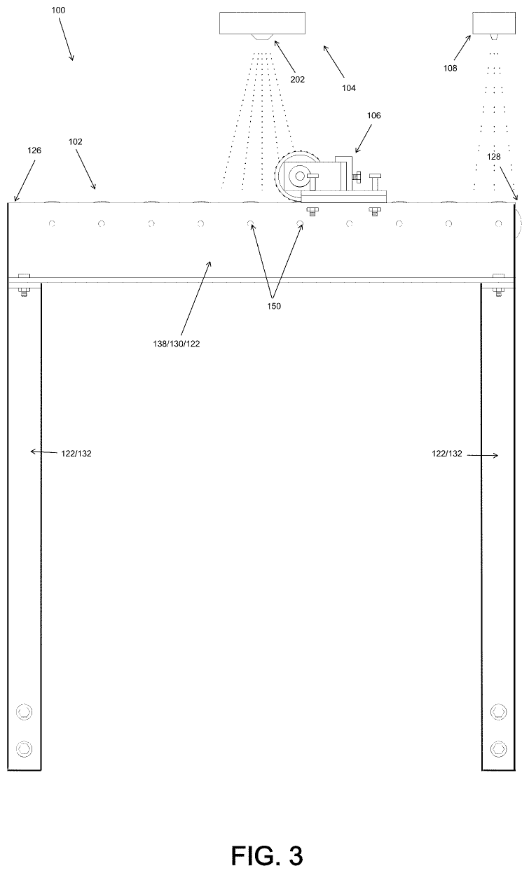

FIG. 4 is a section view of the system for treating wood, the view showing internal components of the conveyor, specifically rollers of the conveyor; the view also showing a heating system formed of a torch or torches, a mechanical press, and a cooling system formed of a sprayer.

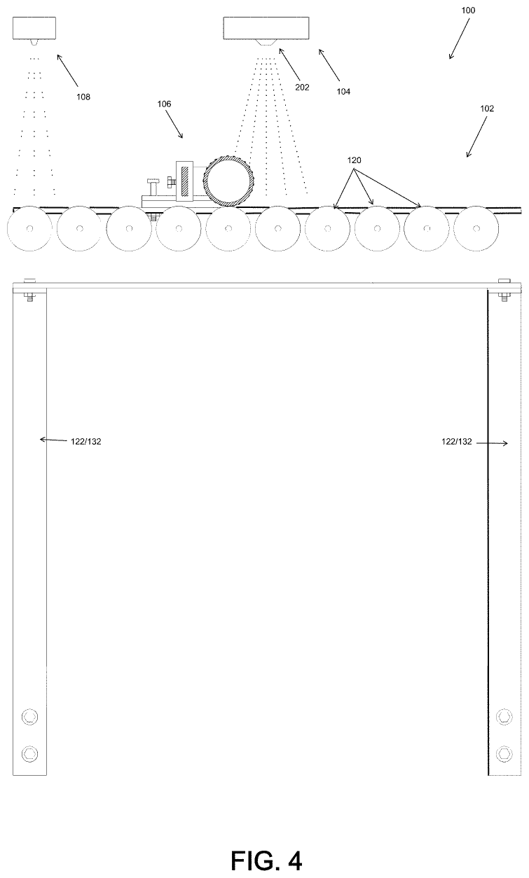

FIG. 5 is a top view of the system for treating wood; the view showing a piece of wood material on rollers of the conveyor, and in the process of passing through the mechanical press, with a portion of the wood material having passed through the mechanical press and having a pattern pressed onto it and the portion of the wood material not yet through the mechanical press having a no pattern pressed on to it; the view showing the mechanical press with a roller having a shaft, a bracket assembly with a mounting member, a movable flange, a stationary flange, an arm, and a collar.

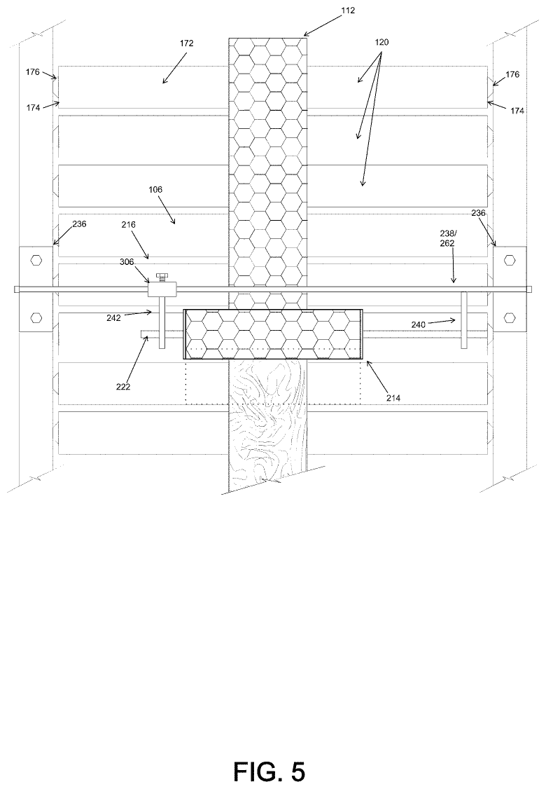

FIG. 6 is a bottom view of the mechanical press and bottom of a piece of wood material in an unprocessed state; the view showing the mechanical press having a roller with a shaft, a body having ends, an exterior surface, and protrusions; the view also showing the mechanical press having bracket assemblies with mounting members, arms, a stationary flange and a movable flange.

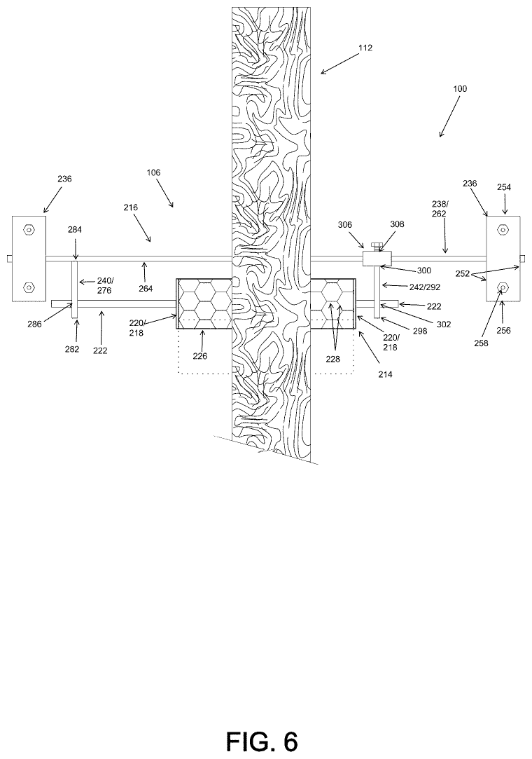

FIG. 7 is a right view of the system for treating wood, the view showing a conveyor with a frame with legs and a crossbar; a machine press having a roller, a bracket assembly, a movable flange, and a stationary flange; and a heating system formed of torches positioned above the machine press and the conveyor.

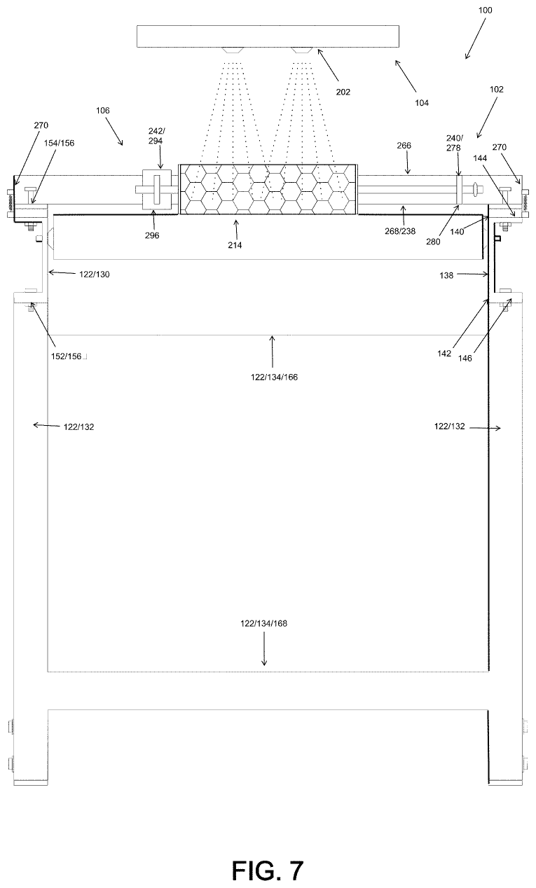

FIG. 8 is a left view of the system for treating wood, the view showing a conveyor with a frame with legs and a crossbar; a machine press having a bracket assembly with mounting members and a bias member; and a heating system formed of torches positioned above the machine press and the conveyor.

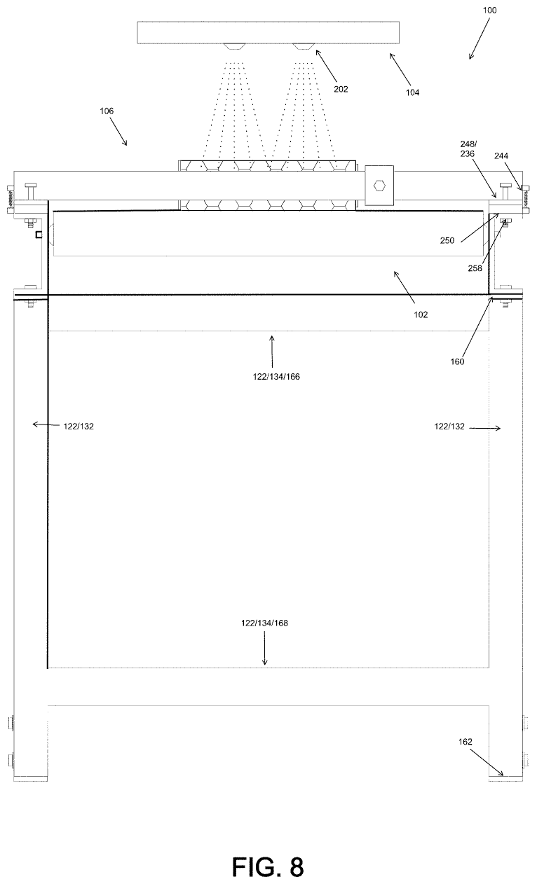

FIG. 9 is a front view of the system for treating wood; the view showing a conveyor with a frame; a heating system formed of a torch or torches; a mechanical press; a cooling system formed of a sprayer; and a motorized feed system, configured to move the wood from the source end to the destination end of the conveyor and the system, formed of a belt, rollers, and a height adjustment assembly.

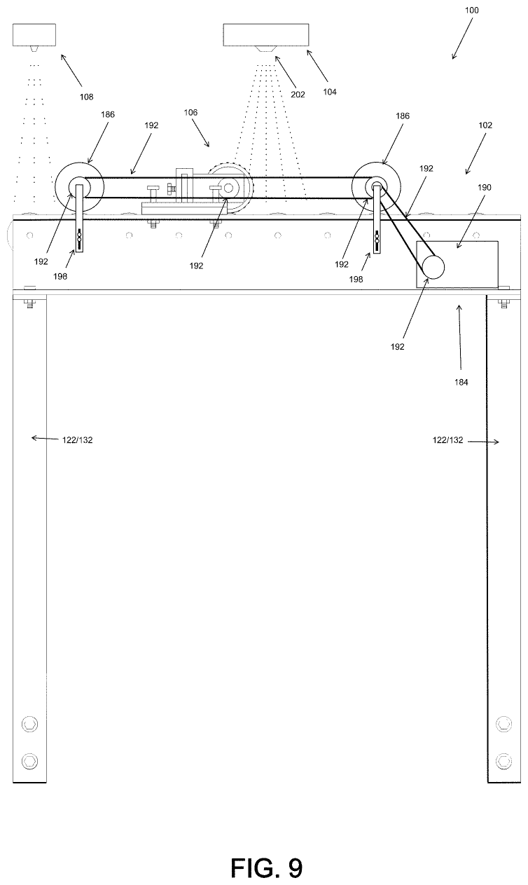

FIG. 10 is a perspective view of the conveyor and mechanical press; the view showing the conveyor with rollers and a frame with siderails and legs; the view also showing the mechanical press with a roller, a bracket assembly, and bearings.

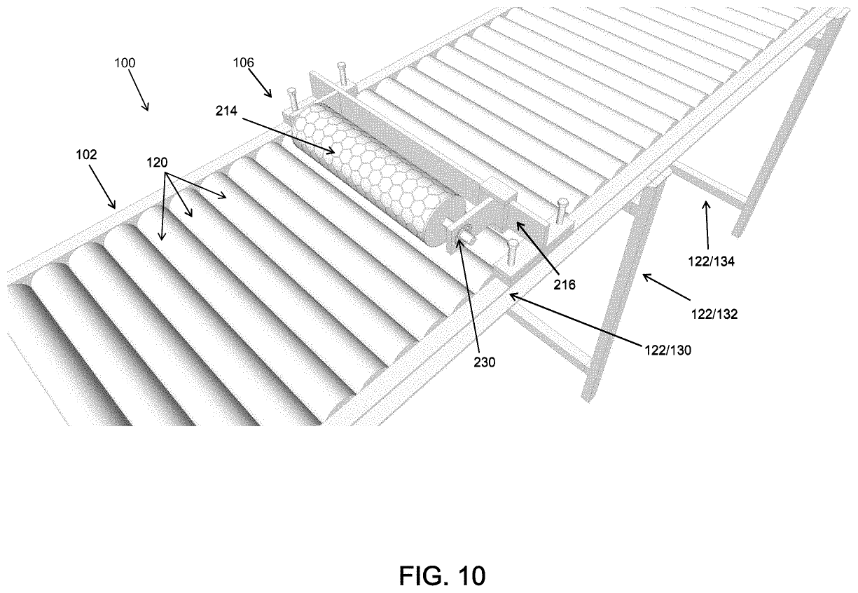

FIG. 11 is another perspective view of the conveyor and mechanical press; the view showing the conveyor with rollers and a frame with siderails and legs; the view also showing the mechanical press with a roller and a bracket assembly.

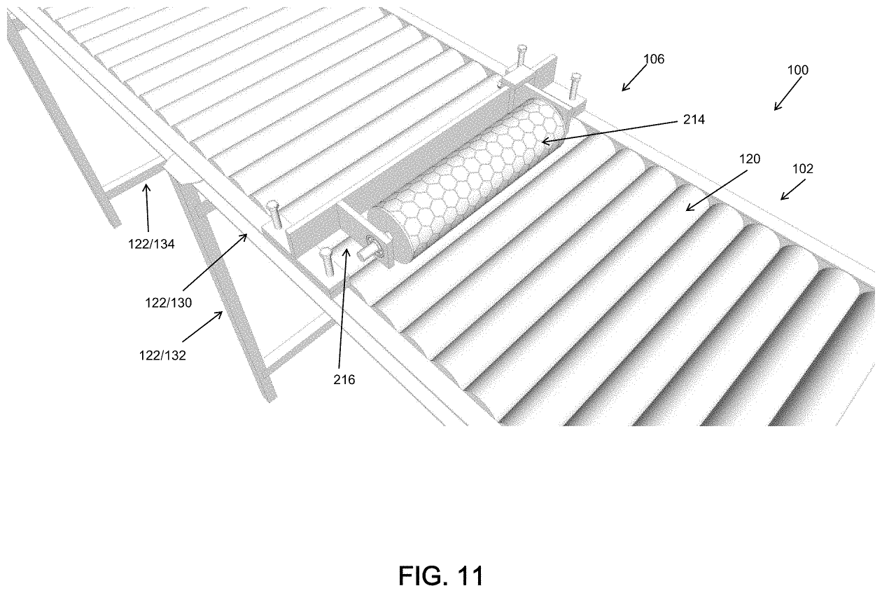

FIG. 12 is another perspective view of the conveyor and mechanical press; the view showing the conveyor with rollers and a frame with siderails and legs; the view also showing the mechanical press with a roller and a bracket assembly.

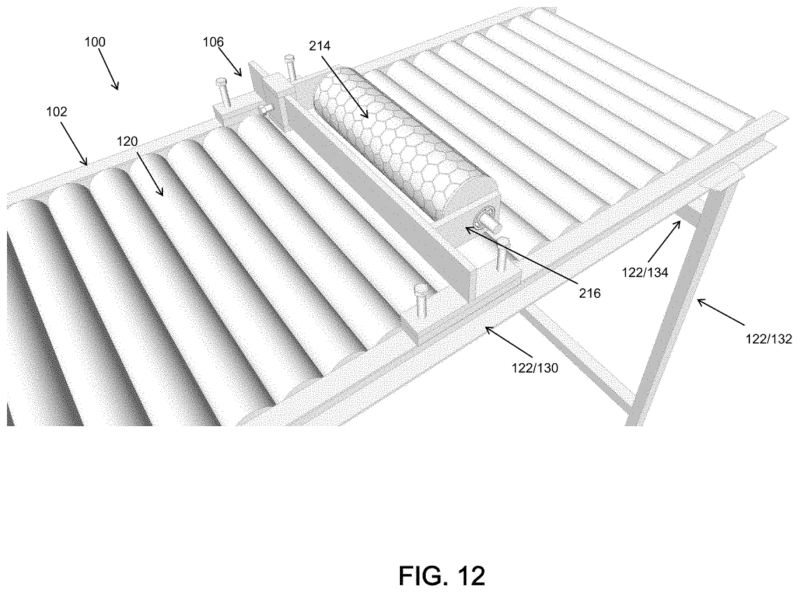

FIG. 13 is another perspective view of the conveyor and mechanical press; the view showing the conveyor with rollers and a frame with siderails and legs; the view also showing the mechanical press with a roller and a bracket assembly.

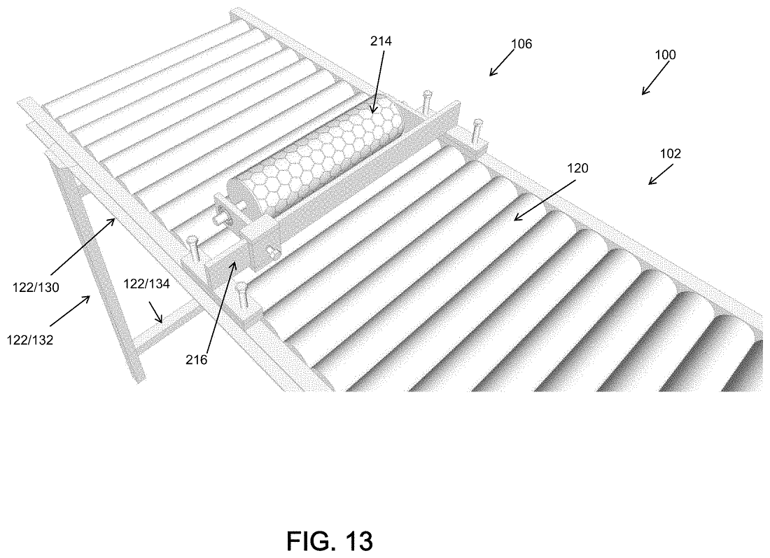

FIG. 14 is a perspective view of the system for treating wood, the view showing a conveyor, a mechanical press, a heating system, and a cooling system.

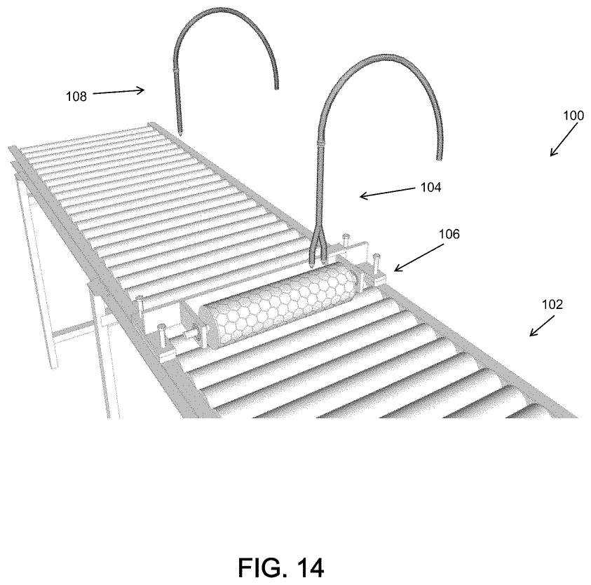

FIG. 15 is an exploded view of the system for treating wood; the view showing a conveyor; a mechanical press having a roller and a bracket assembly with mounting members and an arm, a stationary flange and a movable flange, bearings, a shaft; a heating system with a torch, a connection assembly, a first end, and a second end; and a cooling system with a sprayer, a first end, and a second end.

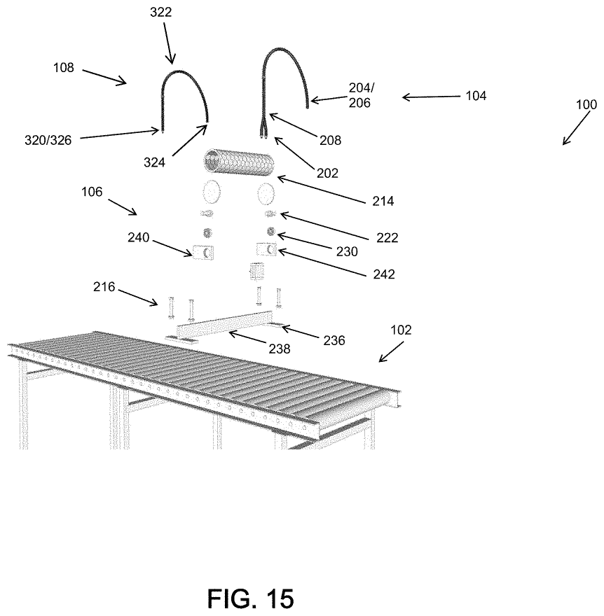

FIG. 16 shows a diagram of the control system; the diagram showing example implementations of a communication circuit, a memory, a processing circuit, a user interface, and sensor(s).

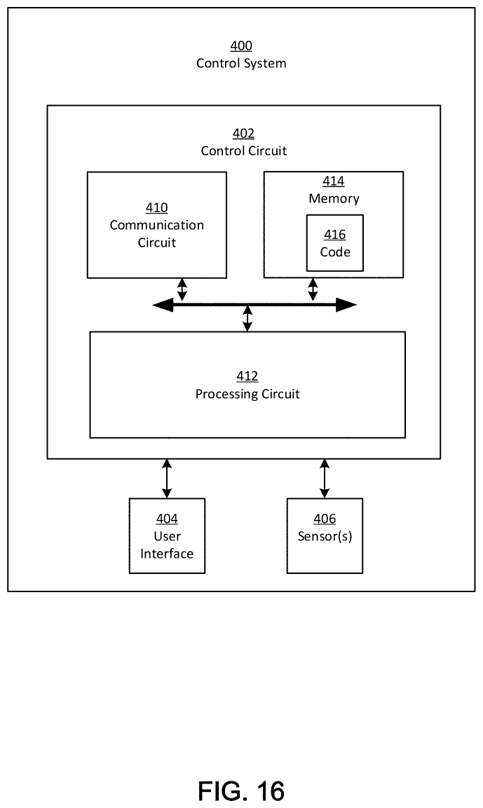

FIG. 17 is a perspective view of the roller of the mechanical press with protrusions in the process of being attached to the body of the roller.

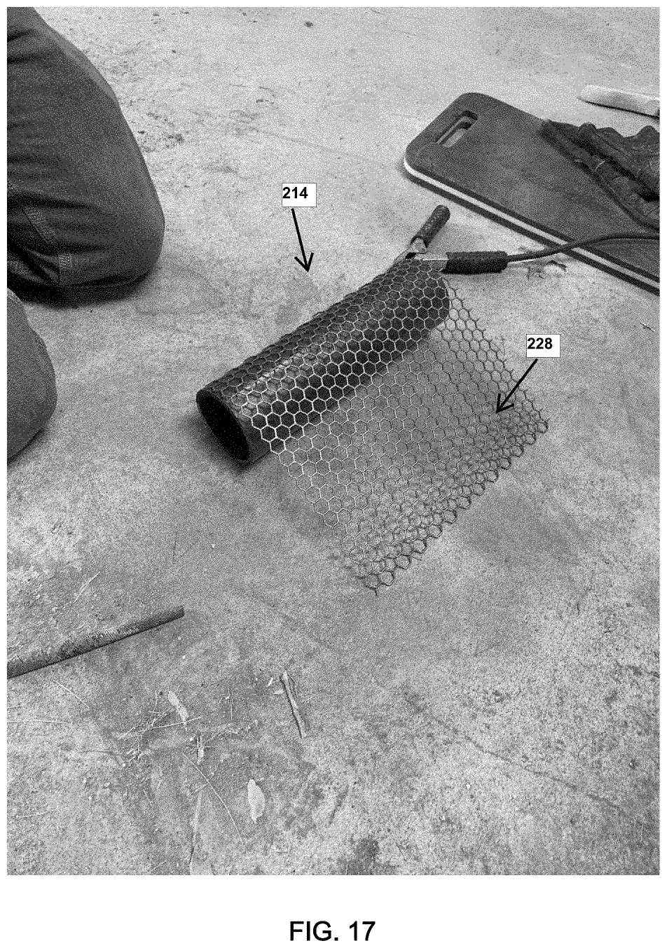

FIG. 18 is another perspective view of the roller of the mechanical press with protrusions attached to the body of the roller.

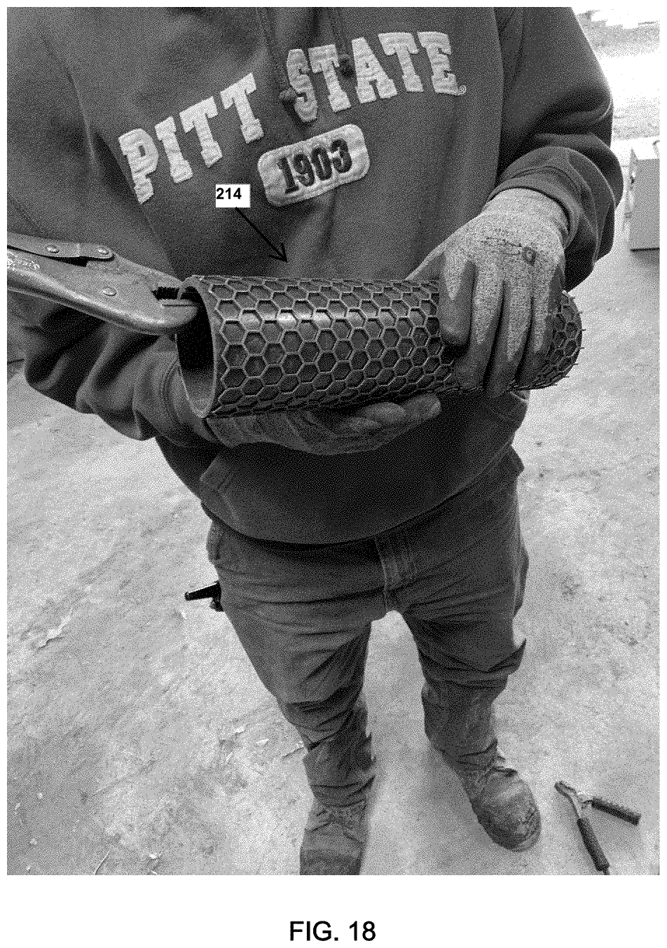

FIG. 19 is a top view of the mechanical press; the view showing the roller attached to the bracket assembly.

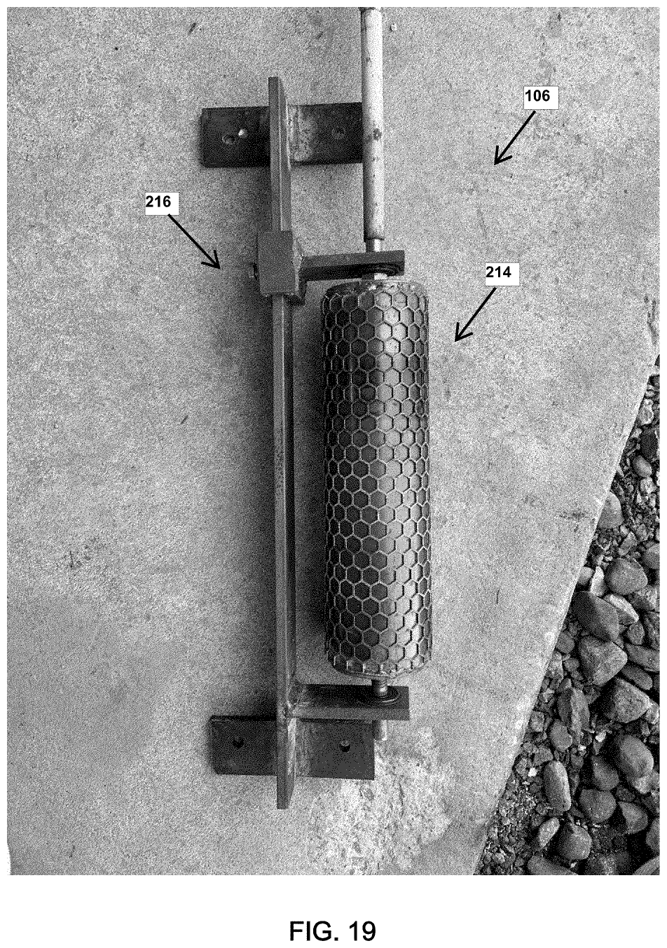

FIG. 20 is a perspective view of the mechanical press; the view showing the roller attached to the bracket assembly.

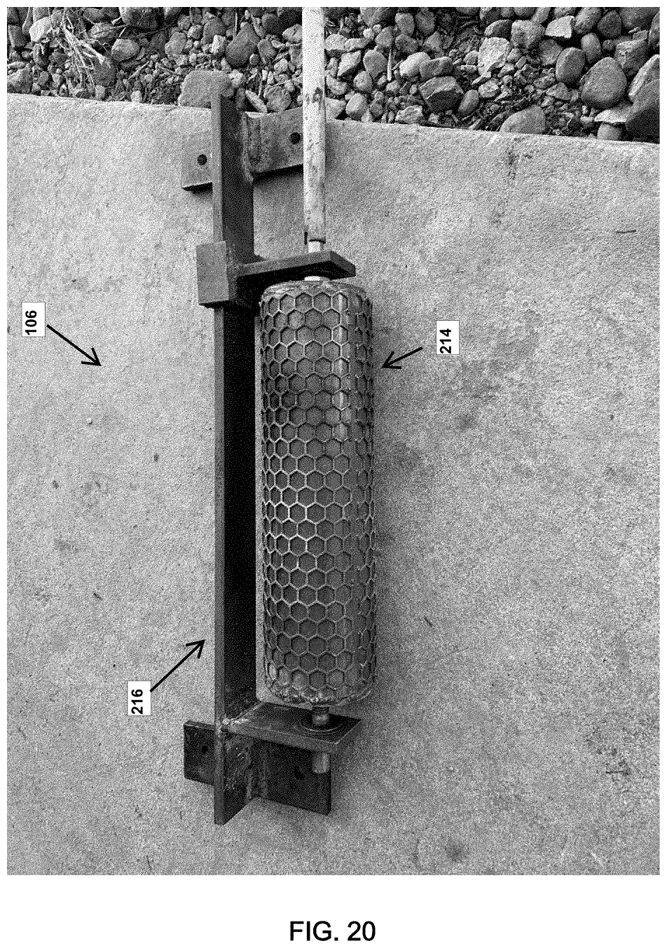

FIG. 21 shows wood material having a honeycomb pattern pressed onto the surface of the wood material.

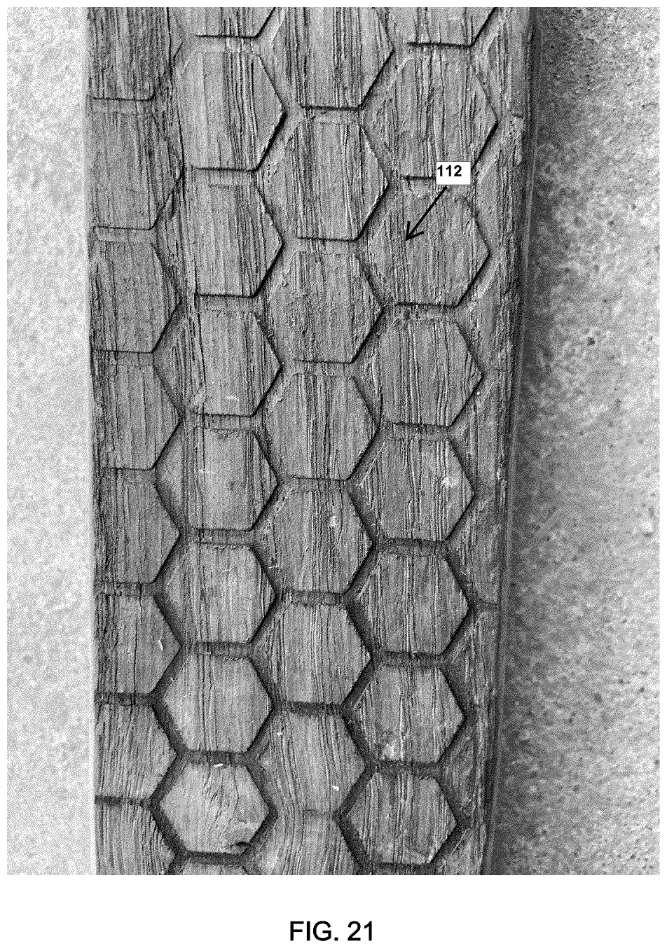

FIG. 22 shows another wood material having a honeycomb pattern pressed onto the surface of the wood material.

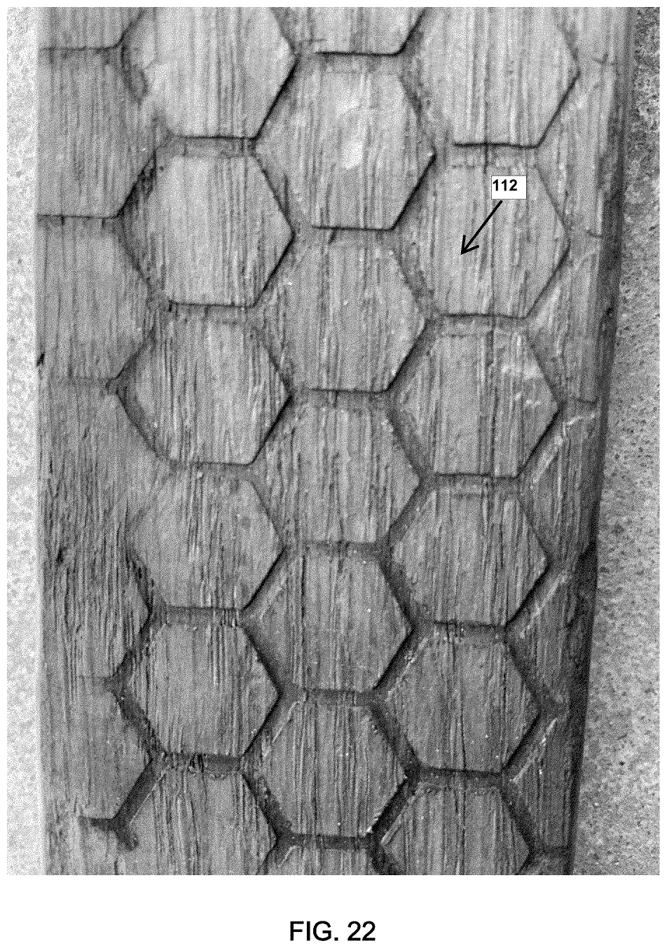

FIG. 23 shows another wood material having a honeycomb pattern pressed onto the surface of the wood material.

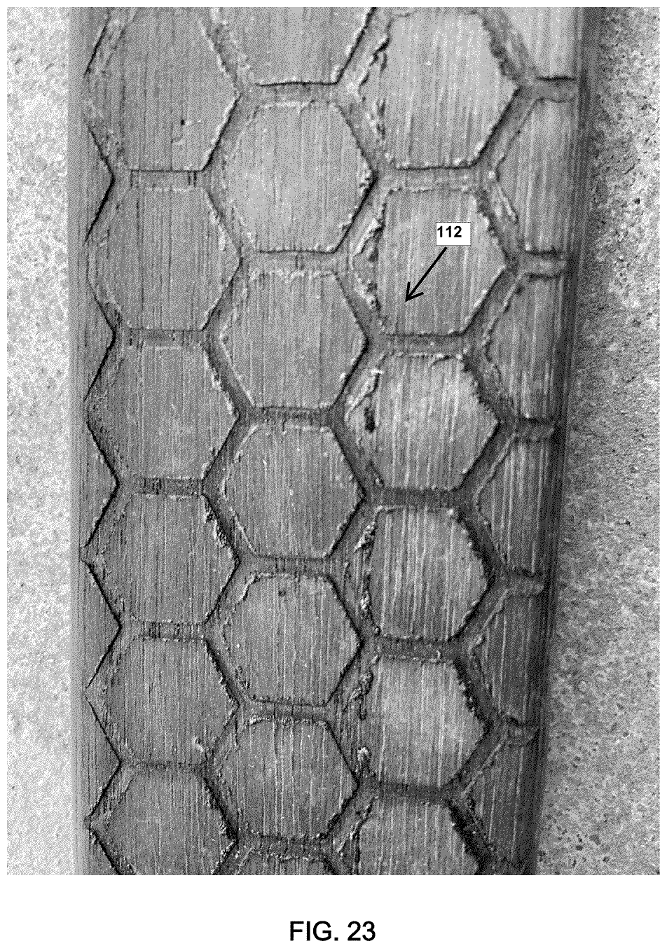

FIG. 24 shows another wood material having a honeycomb pattern pressed onto the surface of the wood material.

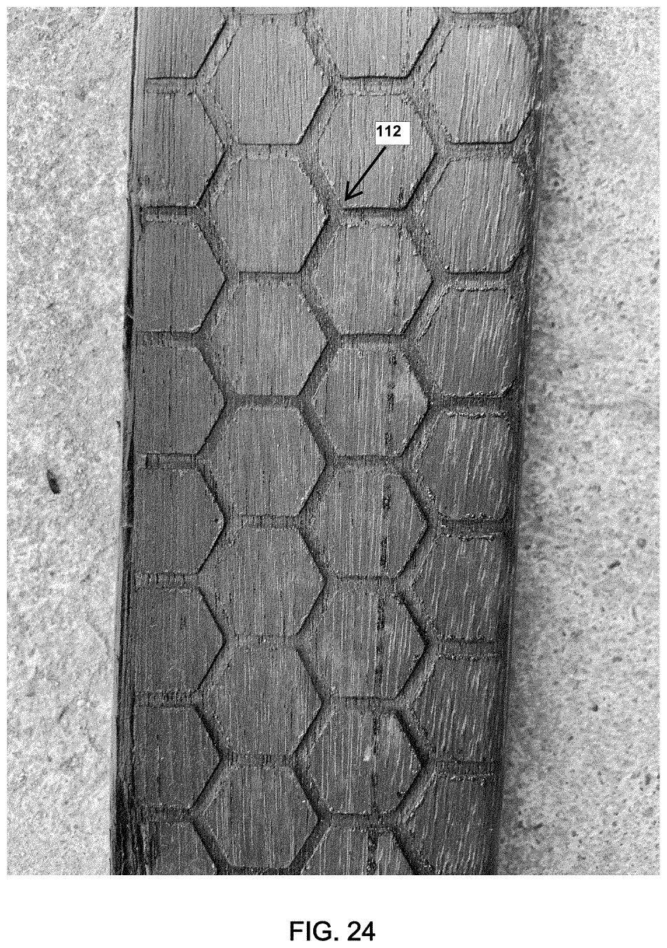

FIG. 25 shows another wood material having a honeycomb pattern pressed onto the surface of the wood material.

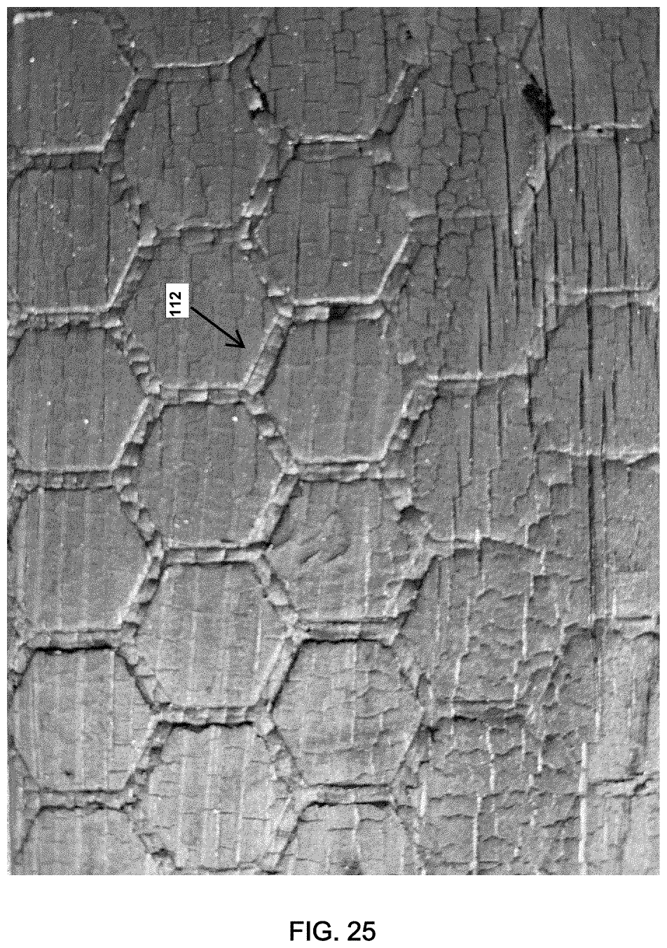

FIG. 26 shows another wood material having a honeycomb pattern pressed onto the surface of the wood material.

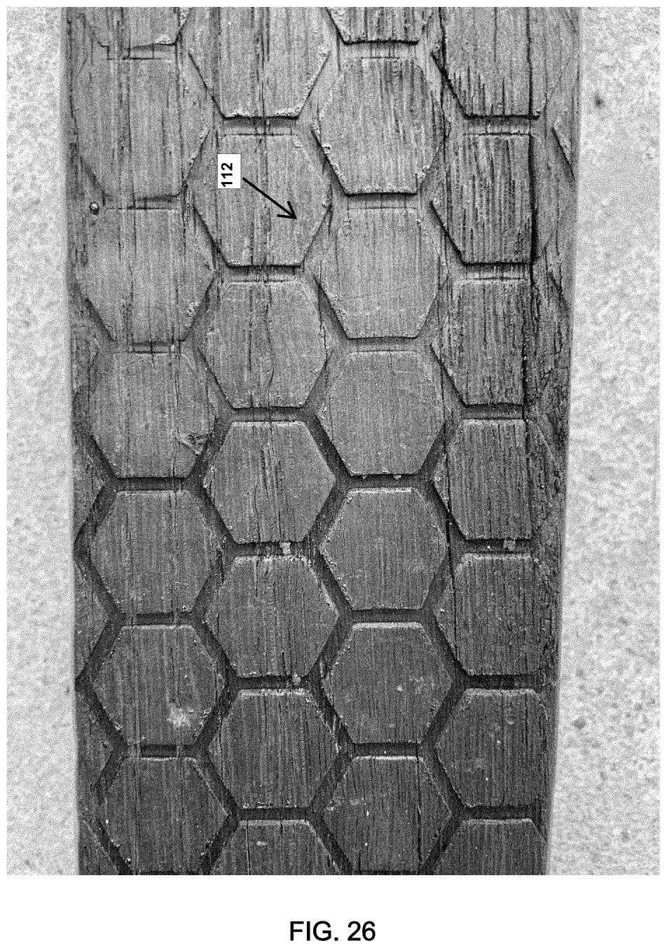

FIG. 27 shows another wood material having a honeycomb pattern pressed onto the surface of the wood material.

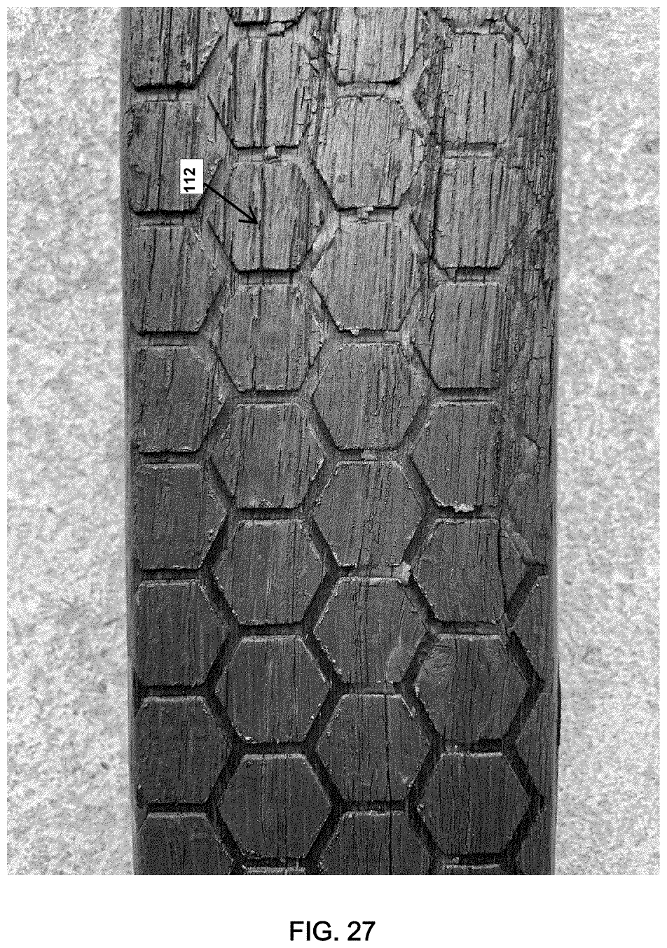

FIG. 28 shows another wood material having a honeycomb pattern pressed onto the surface of the wood material.

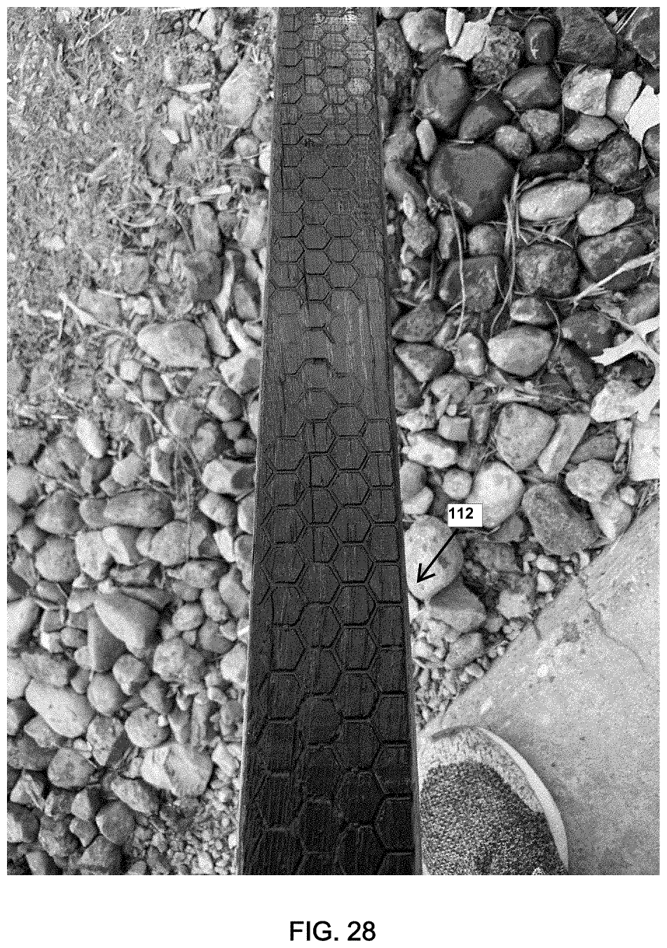

FIG. 29 shows another wood material having a honeycomb pattern pressed onto the surface of the wood material.

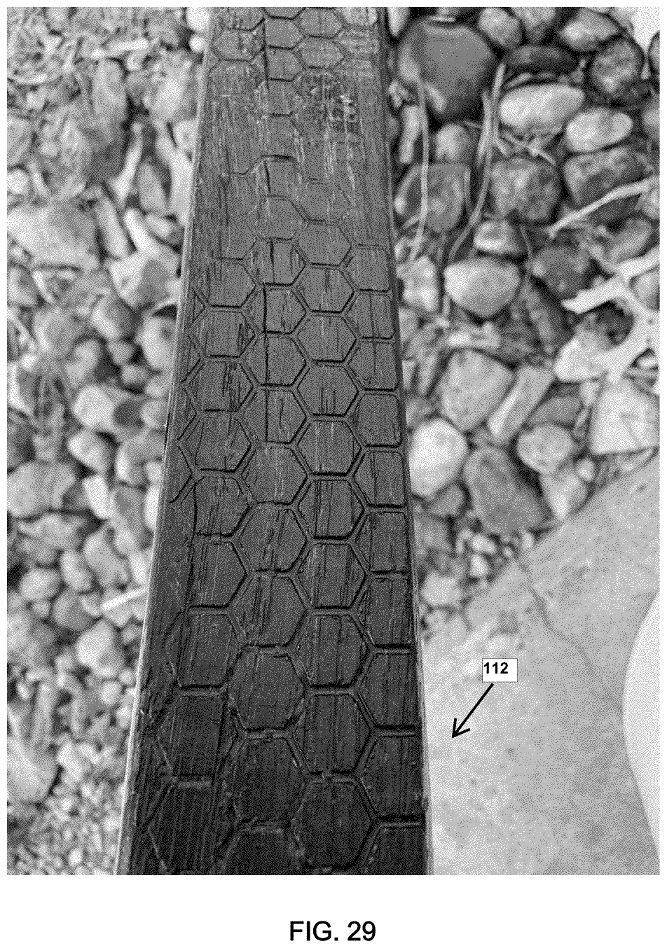

FIG. 30 shows another wood material having a honeycomb pattern pressed onto the surface of the wood material.

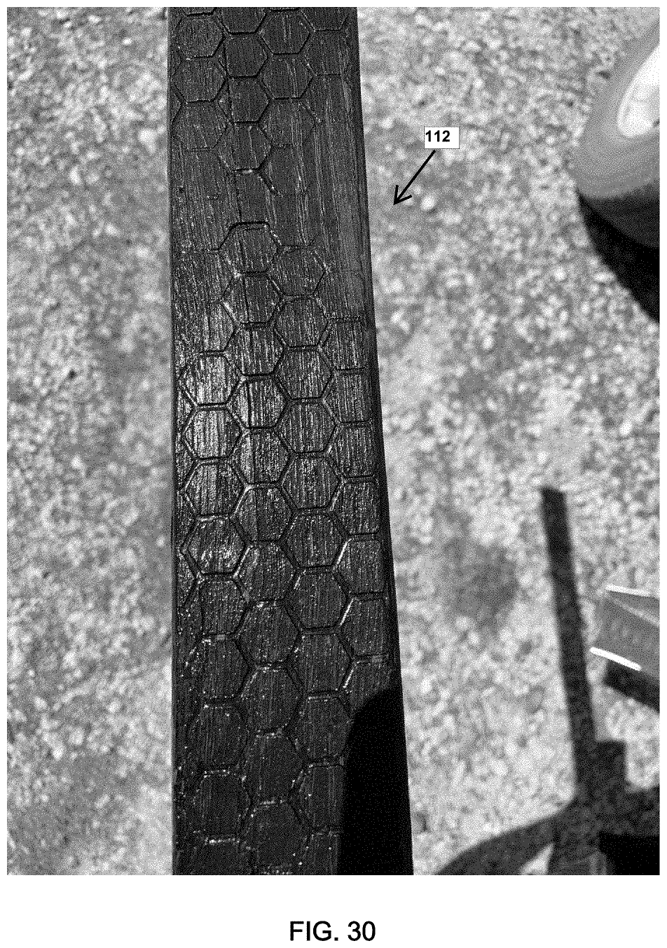

FIG. 31 shows another wood material having a honeycomb pattern pressed onto the surface of the wood material.

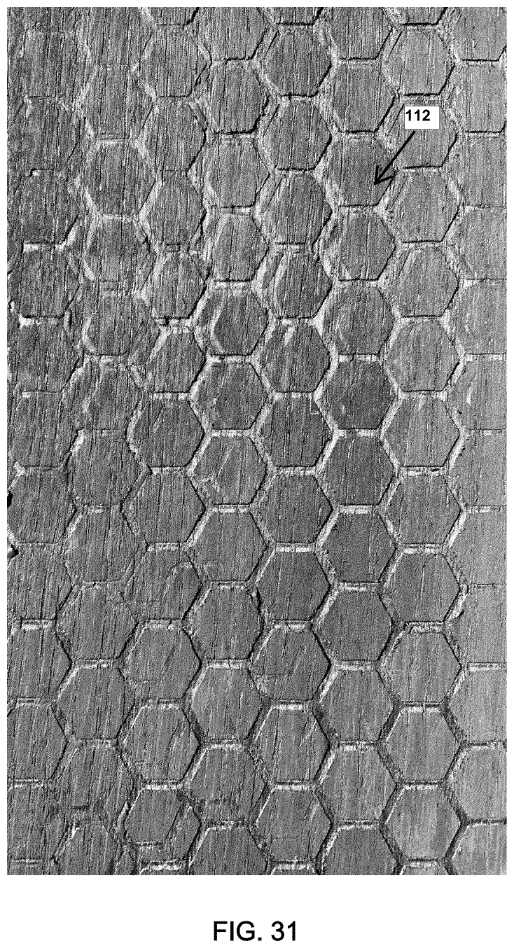

FIG. 32 shows another wood material having a honeycomb pattern pressed onto the surface of the wood material.

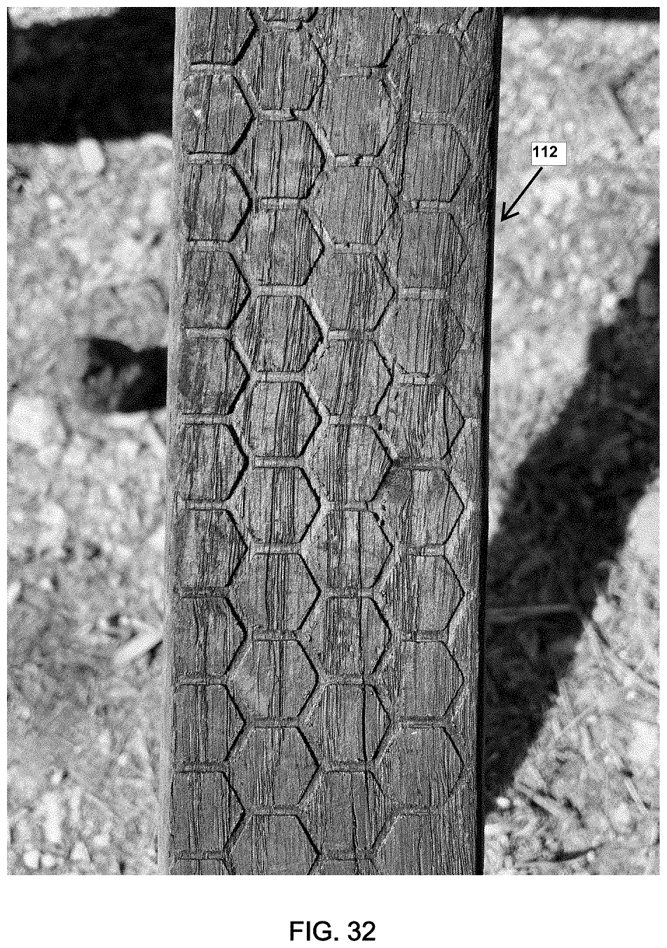

FIG. 33 shows another wood material having a honeycomb pattern pressed onto the surface of the wood material.

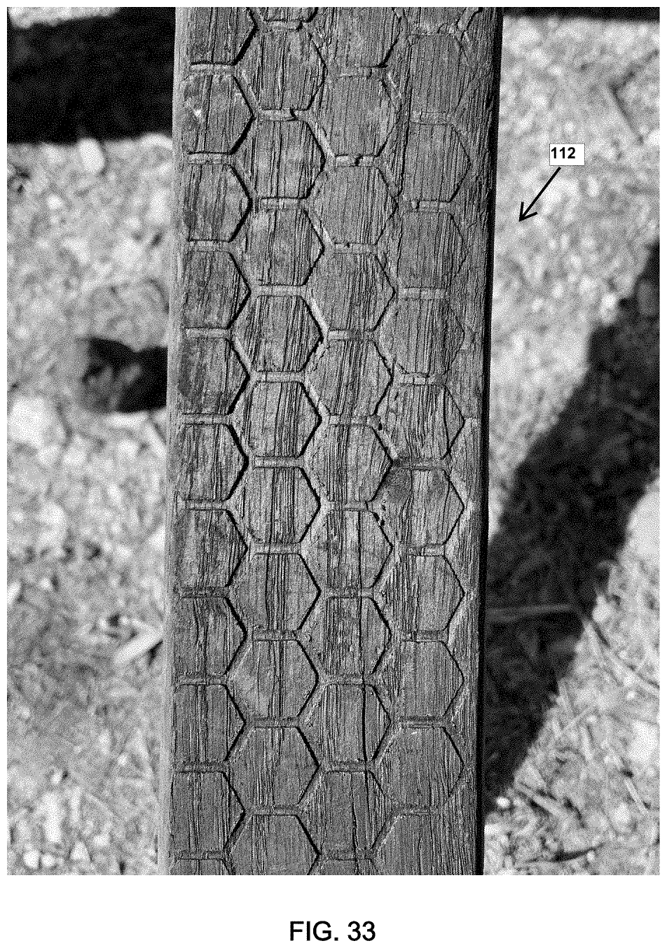

FIG. 34 shows another wood material having a honeycomb pattern pressed onto the surface of the wood material.

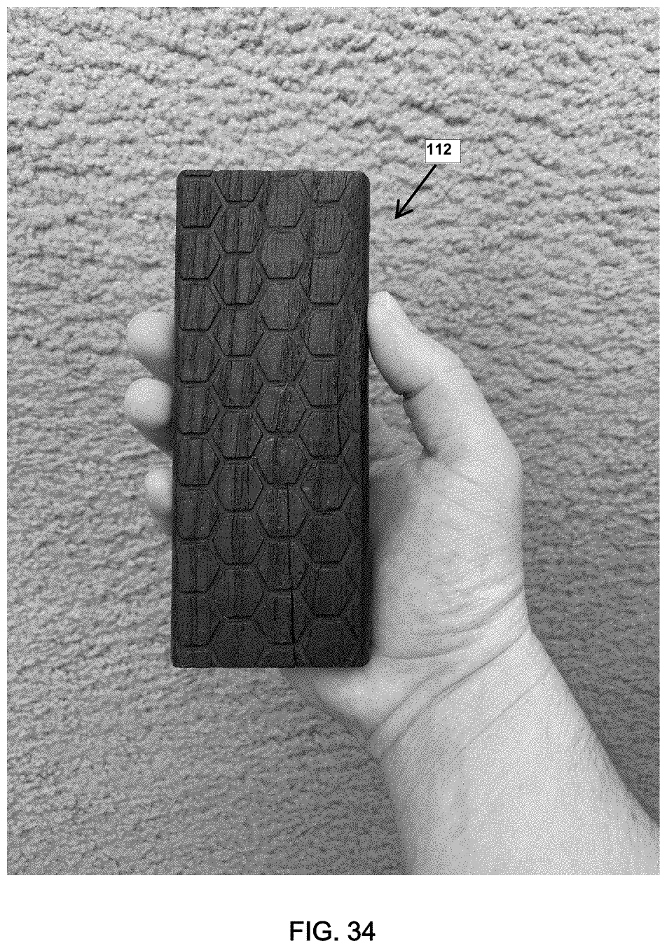

FIG. 35 shows another wood material having a honeycomb pattern pressed onto the surface of the wood material.

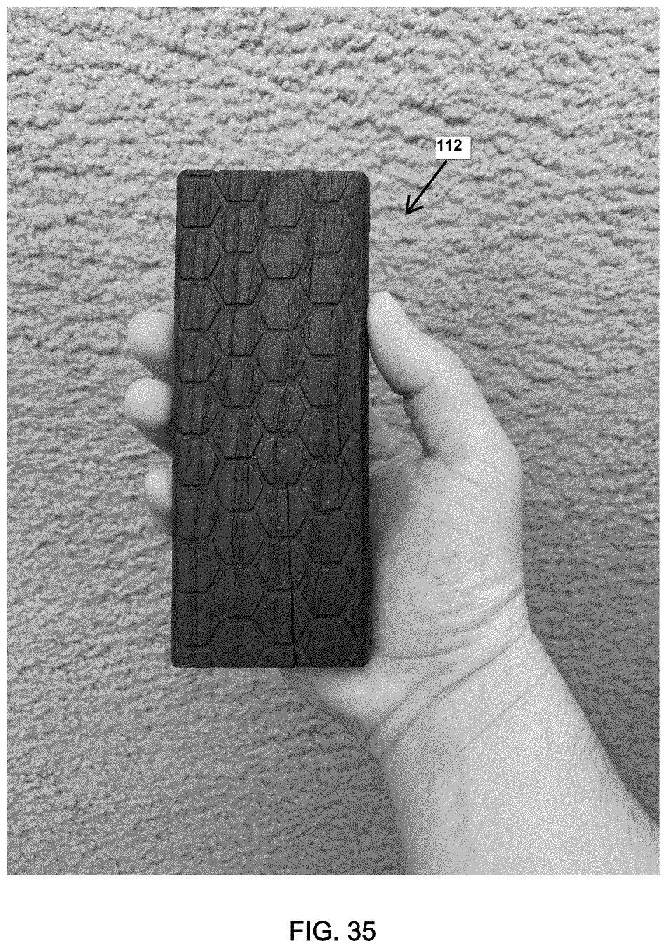

FIG. 36 shows wood material having a lined pattern pressed onto the surface of the wood material.

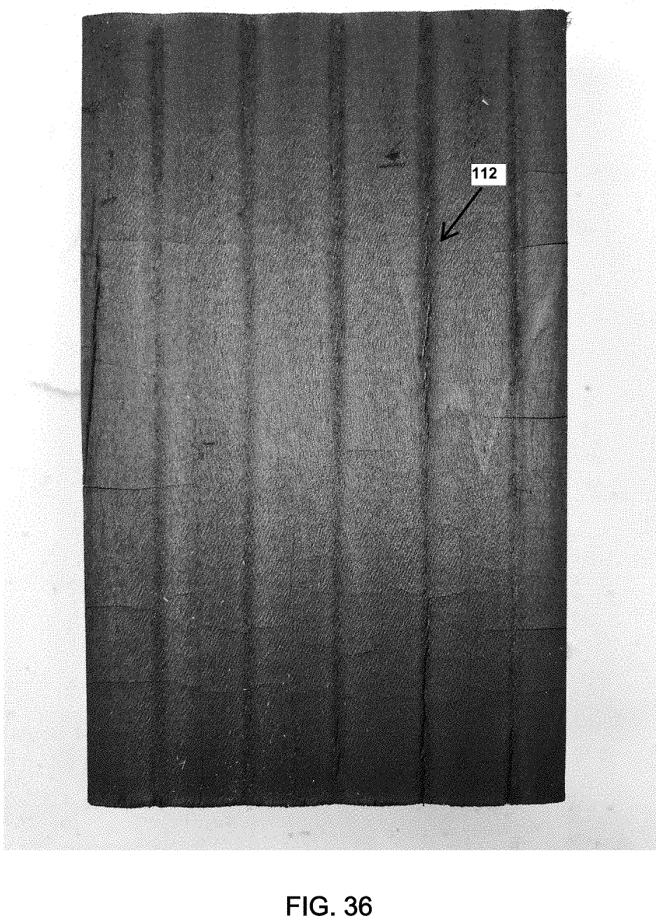

FIG. 37 shows another wood material having a lined pattern pressed onto the surface of the wood material.

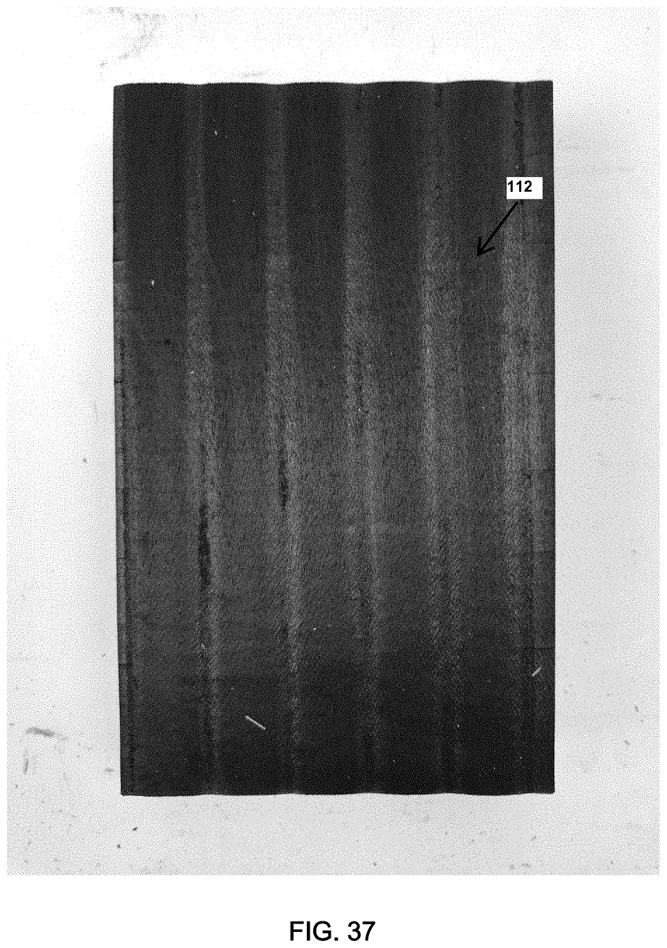

FIG. 38 shows wood material having a diagonal-lined pattern pressed onto the surface of the wood material.

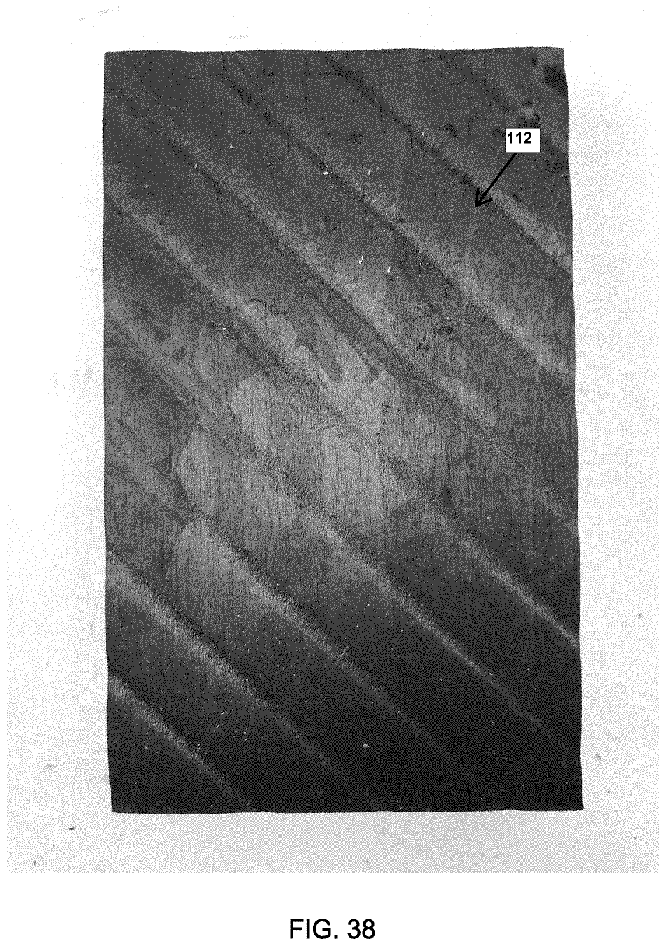

FIG. 39 shows another wood material having a diagonal-lined pattern pressed onto the surface of the wood material.

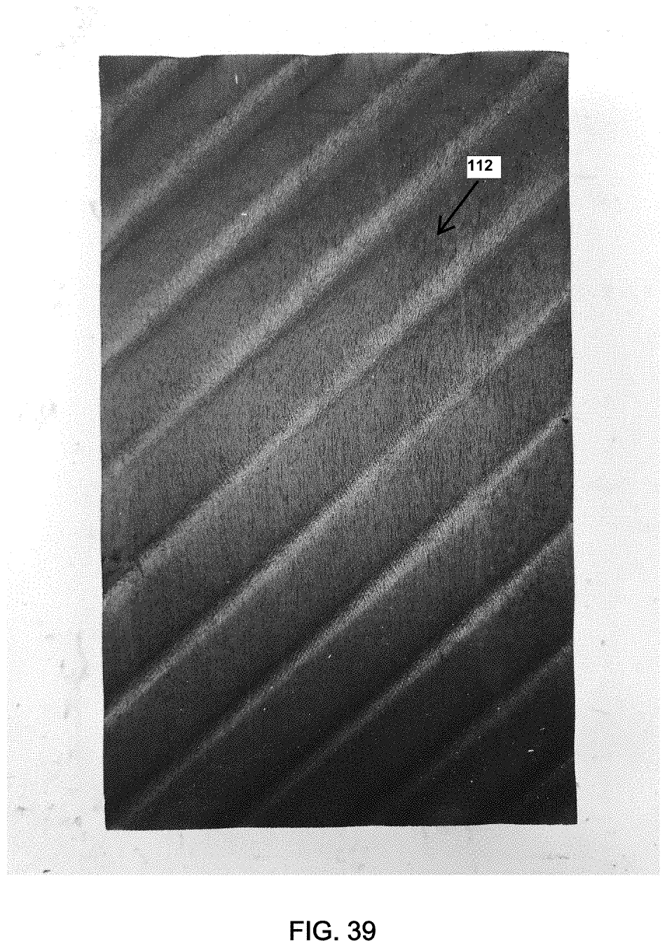

FIG. 40 shows another wood material having a diagonal-lined pattern pressed onto the surface of the wood material.

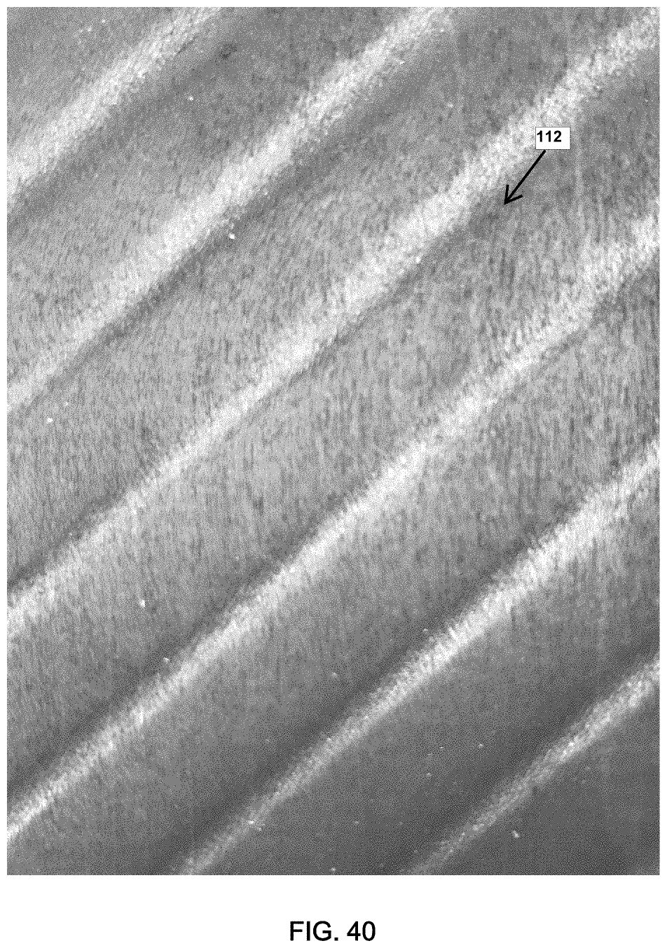

FIG. 41 shows another wood material having a diagonal-lined pattern pressed onto the surface of the wood material.

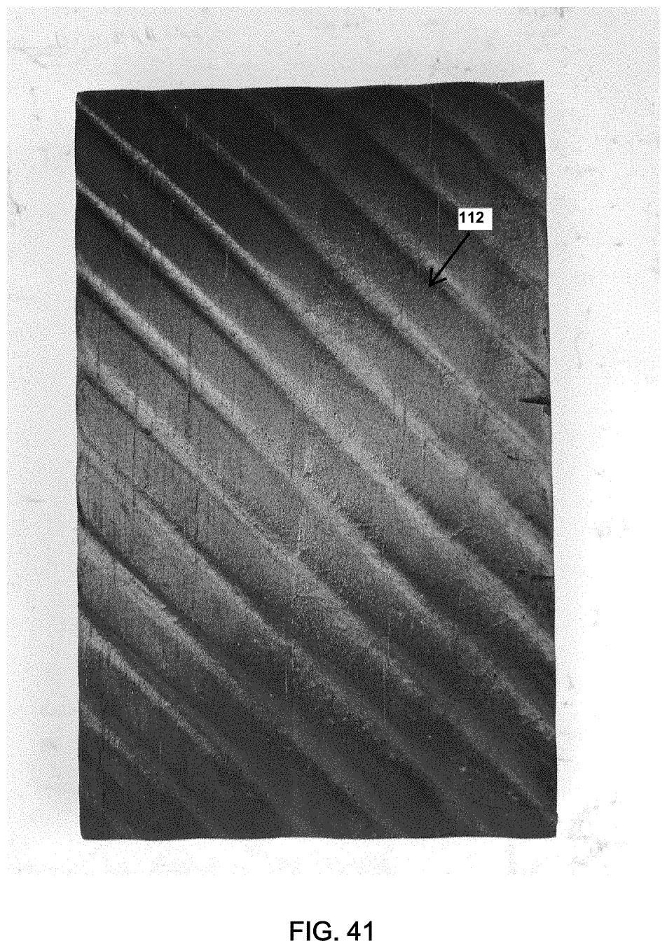

FIG. 42 shows another wood material having a diagonal-lined pattern pressed onto the surface of the wood material.

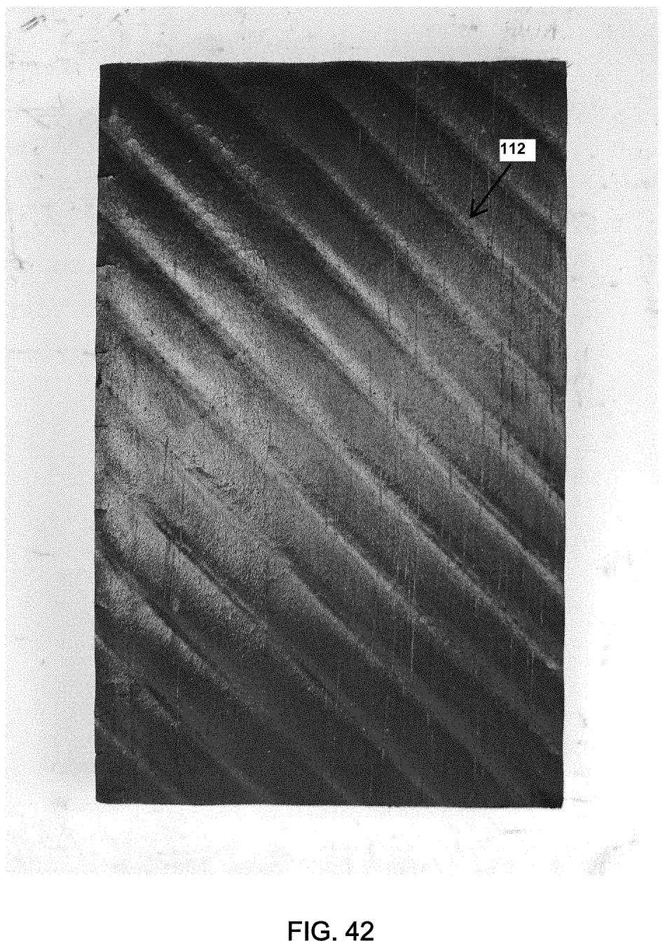

FIG. 43 shows another wood material having a diagonal-lined pattern pressed onto the surface of the wood material.

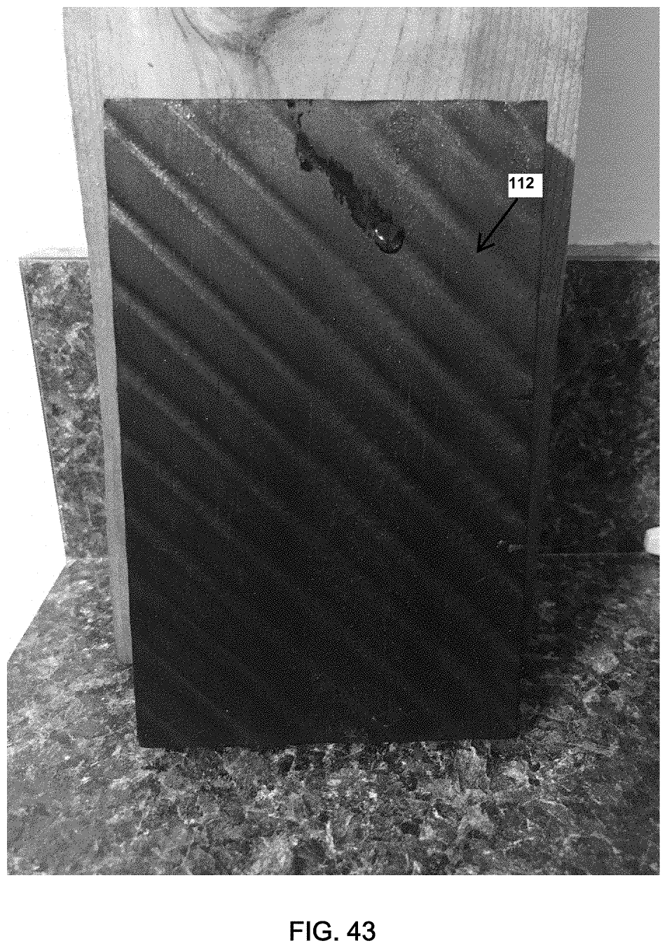

FIG. 44 shows two wood materials; the first wood material having a honeycomb pattern and a darker and more charred surface due to little to no brushing of the surface; the second wood material having a honeycomb pattern and a lighter and less charred surface due to greater brushing of the surface.

FIG. 45 shows two wood materials; the first wood material having a honeycomb pattern and a lighter and less charred surface due to greater brushing of the surface; the second wood material having a honeycomb pattern and a darker and more charred surface due to little to no brushing of the surface.

FIG. 46 shows two wood materials; the first wood material having a honeycomb pattern and a more charred surface due to little to no brushing of the surface; the second wood material having a honeycomb pattern and a less charred surface due to greater brushing of the surface.

FIG. 47 shows three wood materials; the first wood material having a honeycomb pattern and a lighter and less charred surface due to greater brushing of the surface; the second wood material having a darker and more charred surface due to little to no brushing of the surface; and the third wood material being unprocessed, with no charring or pattern on its surface.

### DETAILED DESCRIPTION OF THE DISCLOSURE

In the following detailed description of the embodiments, reference is made to the accompanying drawings which form a part hereof, and in which is shown by way of illustration specific embodiments in which the disclosure may be practiced. The embodiments of the present disclosure described below are not intended to be exhaustive or to limit the disclosure to the precise forms in the following detailed description. Rather, the embodiments are chosen and described so that others skilled in the art may appreciate and understand the principles and practices of the present disclosure. It will be understood by those skilled in the art that various changes in form and details may be made without departing from the principles and scope of the invention. It is intended to cover various modifications and similar arrangements and procedures, and the scope of the appended claims therefore should be accorded the broadest interpretation to encompass all such modifications and similar arrangements and procedures. For instance, although aspects and features may be illustrated in and/or described with reference to certain figures and/or embodiments, it will be appreciated that features from one figure and/or embodiment may be combined with features of another figure and/or embodiment even though the combination is not explicitly shown and/or explicitly described as a combination. In the depicted embodiments, like reference numbers refer to like elements throughout the various drawings.

Any advantages and/or improvements discussed herein may not be provided by various disclosed embodiments, and/or implementations thereof. The contemplated embodiments are not so limited and should not be interpreted as being restricted to embodiments which provide such advantages and/or improvements. Similarly, it should be understood that various embodiments may not address all or any objects of the disclosure and/or objects of the invention that may be described herein. The contemplated embodiments are not so limited and should not be interpreted as being restricted to embodiments which address such objects of the disclosure and/or invention. Furthermore, although some disclosed embodiments may be described relative to specific materials, embodiments are not limited to the specific materials and/or apparatuses but only to their specific characteristics and capabilities and other materials and apparatuses can be substituted as is well understood by those skilled in the art in view of the present disclosure.

It is to be understood that the terms such as “left, right, top, bottom, front, back, side, height, length, width, upper, lower, interior, exterior, inner, outer, and the like as may be used herein, merely describe points of reference and do not limit the present invention to any particular orientation and/or configuration.

As used herein, “and/or” includes all combinations of one or more of the associated listed items, such that “A and/or B” includes “A but not B,” “B but not A,” and “A as well as B,” unless it is clearly indicated that only a single item, subgroup of items, or all items are present. The use of “etc.” is defined as “et cetera” and indicates the inclusion of all other elements belonging to the same group of the preceding items, in any “and/or” combination(s).

As used herein, the singular forms “a,” “an,” and “the” are intended to include both the singular and plural forms, unless the language explicitly indicates otherwise. Indefinite articles like “a” and “an” introduce or refer to any modified term, both previously-introduced and not, while definite articles like “the” refer to a same previously-introduced term; as such, it is understood that “a” or “an” modify items that are permitted to be previously-introduced or new, while definite articles modify an item that is the same as immediately previously presented. It will be further understood that the terms “comprises,” “comprising,” “includes,” and/or “including,” when used herein, specify the presence of stated features, characteristics, steps, operations, elements, and/or components, but do not themselves preclude the presence or addition of one or more other features, characteristics, steps, operations, elements, components, and/or groups thereof, unless expressly indicated otherwise. For example, if an embodiment of a system is described as comprising an article, it is understood the system is not limited to a single instance of the article unless expressly indicated otherwise, even if elsewhere another embodiment of the system is described as comprising a plurality of such articles.

It will be understood that when an element is referred to as being “connected,” “coupled,” “mated,” “attached,” “fixed,” etc. to another element, it can be directly connected to the other element, and/or intervening elements may be present. In contrast, when an element is referred to as being “directly connected,” “directly coupled,” “directly engaged” etc. to another element, there are no intervening elements present. Other words used to describe the relationship between elements should be interpreted in a like fashion (e.g., “between” versus “directly between,” “adjacent” versus “directly adjacent,” “engaged” versus “directly engaged,” etc.). Similarly, a term such as “operatively”, such as when used as “operatively connected” or “operatively engaged” is to be interpreted as connected and/or engaged, respectively, in any manner that facilitates operation, which may include being directly connected, indirectly connected, electronically connected, wirelessly connected and/or connected by any other manner, method and/or means that facilitates desired operation. Similarly, a term such as “communicatively connected” includes all variations of information exchange and routing between two electronic devices, including intermediary devices, networks, etc., connected wirelessly or not. Similarly, “connected” or other similar language particularly for electronic components is intended to mean connected by any means, either directly or indirectly, wired and/or wirelessly, such that electricity and/or information may be transmitted between the components.

It will be understood that, although the ordinal terms “first,” “second,” etc. may be used herein to describe various elements, these elements should not be limited to any order by these terms unless specifically stated as such. These terms are used only to distinguish one element from another; where there are “second” or higher ordinals, there merely must be a number of elements, without necessarily any difference or other relationship. For example, a first element could be termed a second element, and, similarly, a second element could be termed a first element, without departing from the scope of example embodiments and/or methods.

Similarly, the structures and operations discussed herein may occur out of the order described and/or noted in the figures. For example, two operations and/or figures shown in succession may in fact be executed concurrently and/or may sometimes be executed in the reverse order, depending upon the functionality/acts involved. Similarly, individual operations within example methods described below may be executed repetitively, individually, and/or sequentially, to provide looping and/or other series of operations aside from single operations described below. It should be presumed that any embodiment and/or method having features and functionality described below, in any workable combination, falls within the scope of example embodiments.

As used herein, various disclosed embodiments may be primarily described in the context of treatment of wood. However, the embodiments are not so limited. It is appreciated that the embodiments may be adapted for use with other applications which may be improved by the disclosed structures, arrangements and/or methods. The system is merely shown and described as being used in the context of wood treatment for ease of description and as one of countless examples.

### Method for Treating Wood:

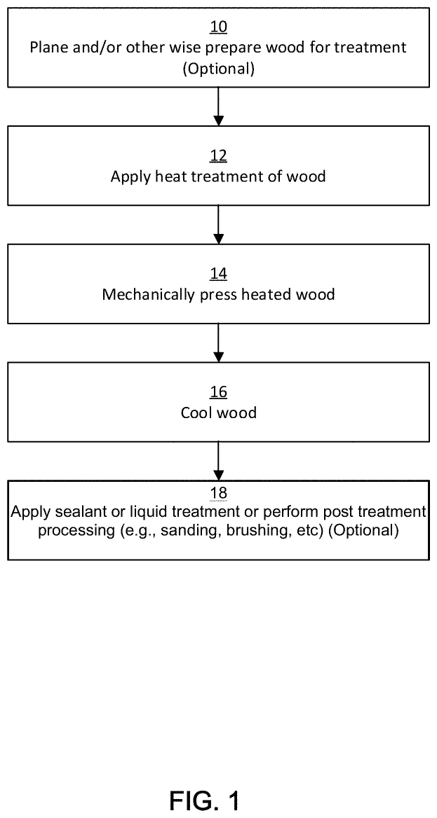

In one or more arrangements, a method for treating wood is provided. FIG. 1 shows a flow chart of an example method for treating wood, in accordance with one or more embodiments. In this example arrangement, the process begins at process block 10. At process block 10, a piece of wood material 112 may optionally be prepared for treatment. Preparation of wood material 112 may include various processes including but not limited to, for example, planing the wood material 112, sanding the wood material 112, cutting the wood material 112, shaping the wood material 112, applying chemical to the wood material 112, drying the wood material 112, acetylating the wood material 112, and/or any other processing of wood material 112. After preparation of the piece of wood material 112 at process block 10 (if any preparation is performed), the process proceeds to process block 12.

At process block 12, heat is applied to the piece of wood material 112. The wood material 112 may be heated using any suitable method or means for heating wood material 112 for treatment. In one or more arrangements, the piece of wood material 112 is heated by passing the piece of wood under fire (e.g., a 400,000-600,000 BTU torch or torches). However, the embodiments are not so limited. Rather, it is contemplated that various different arrangements may apply heat using various known methods or means including but not limited to fire (e.g., provided by torches and/or other open flame sources), electric heat elements, radiant heating elements, heated air, and/or any other method of means for generating heat. In some arrangements, heat may be applied from the heat source to the piece of wood directly. Additionally or alternatively, in some arrangements, heat may be applied from the heat source to the piece of wood material 112 indirectly by transferring to the piece of wood material 112 through a conductive object. The process of heating the wood is designed to char the surface, or said another way, carbonize the surface, of the wood material 112. In one or more arrangements, the charring or carbonizing of the surface can be done either through direct contact or aim of the flame or heat source at the surface of the wood material 112, or indirect heating of the surface of wood material 112.

Before, during, or after the wood material 112 is being heated in process block 12, the piece of wood material 112 is mechanically pressed at process block 14. The wood material 112 may be pressed using any suitable method or means for applying pressure to the wood material 112. In arrangements shown, as examples, the piece of wood material 112 is mechanically pressed by a roller 214 and the pressure is applied to wood material 112 as it is rolled underneath roller 214 of the mechanical press 106. Additionally or alternatively, in alternative arrangements, as examples, the piece of wood material 112 may be mechanically pressed by a mechanical press 106 applying pressure to all or a portion of the piece of wood material 112 at one time. In this arrangement, as one example, mechanical press 106 may include a plate, stamp, or other mechanism with a surface capable of applying downward force to an area, to apply downward force to the top of all or a portion of a piece of wood material 112 and/or multiple pieces of wood material 112 at once.

After pressing of the wood material 112 at process block 14, the piece of wood material 112 is cooled at process block 16. The wood material 112 may be cooled using any suitable method or means for cooling. In one or more arrangements, the wood material 112 is cooled by spraying the wood with water and/or other liquid coolant. This step may help prevent the wood material 112 from subsequently catching on fire. However, the embodiments are not so limited. Rather, it is contemplated that various different arrangements may cool the wood material 112 using various known methods or means including but not limited to, for example, spraying with water and/or liquid coolant, bath in water and/or liquid coolant, cooling in the ambient environment, fans, chilled air, transfer of heat from the wood to a heat sink or other object via conduction and/or any other method of means for cooling.

In some arrangements, the piece of wood material 112 may optionally be patterned while being pressed by the mechanical press. For example, in one or more arrangements, a surface of the mechanical press may include a set of protrusions that form patterned depressions on a surface of the wood material 112 when pressed. Additionally or alternatively, wood material 112 may be patterned before or after wood material 112 is pressed. In such illustrative examples, the mechanical press does not include a set of protrusions, rather the mechanical press is smooth and the pattern is formed onto the wood material through a stamping process or other process separate from the pressing process and the forming of the pattern may be done before or after the pressing process performed in process block 14. In one or more arrangements, as examples, the set of protrusions are less than or equal to one-eighth inch in depth and/or width, however in other arrangements, as examples, the set of protrusions may exceed one-eight inch in depth and/or width. In one or more arrangements, such patterns may be useful to provide wood pieces having an aesthetically pleasing appearance. Additionally or alternatively, such patterns may be helpful to control where precipitation sheds and weathering occurs along the surface of the wood material 112, or where cracks may form as the wood material 112 matures.

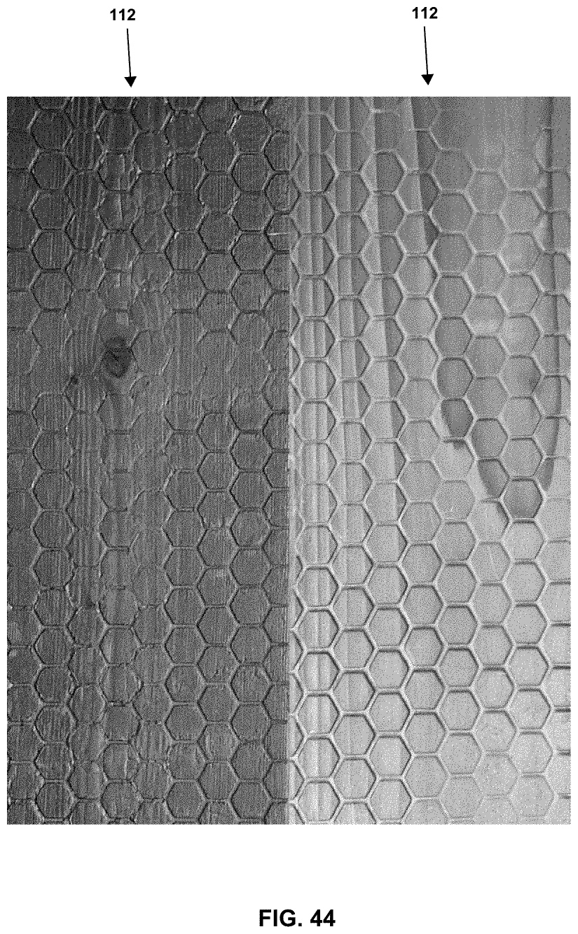

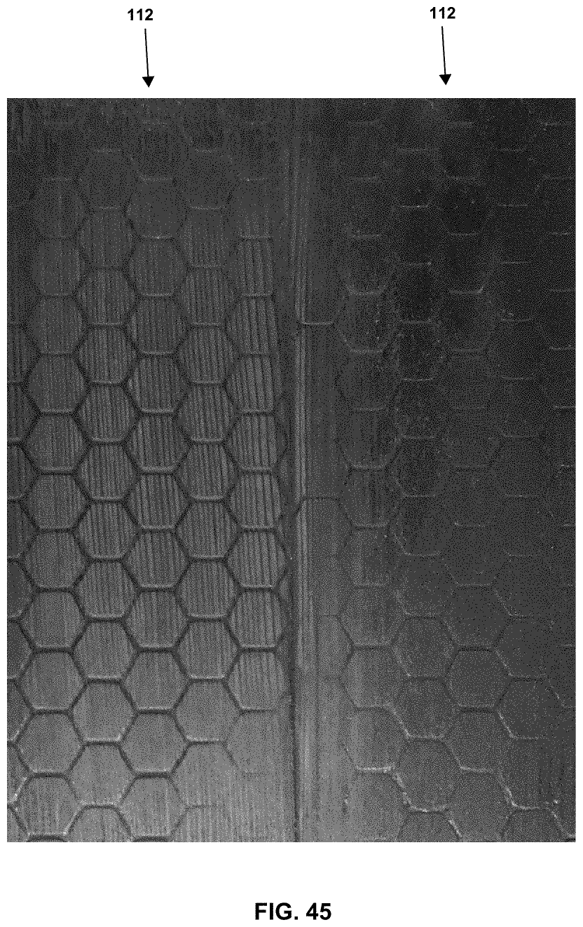

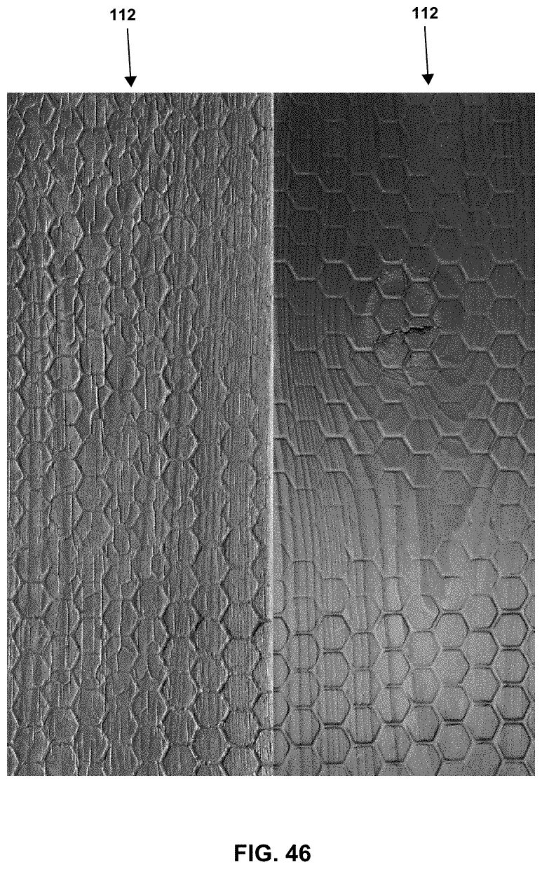

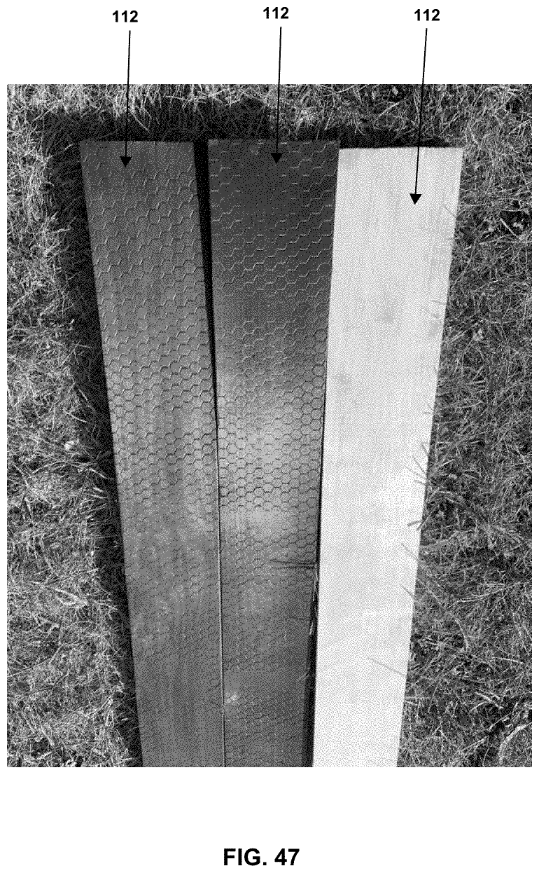

At process block 18, the piece of wood material 112 may optionally be treated with one or more additional treatment processes. Such additional treatment processes may include various processes including but not limited to, for example, applying a sealant or other treatment, applying a stain, painting, sanding, planning, brushing, cutting, drying, and/or any other processing of wood material 112. As one illustrative example, a sealant may be applied to affect the dullness or shininess of the wood material 112 and the amount and type of sealant applied can be adjusted to match the desired aesthetic for wood material 112. As an illustrative example, brushing may be performed to remove any amount of char (including some or all of the char) and change the color of the wood material followed by application of a sealant. In one or more illustrative examples, the more char that is brushed off the wood material, the lighter the material is. This can be seen in images shown in FIGS. 44-47, as examples. Said another way, the more char that is brushed off the wood material 112 in post treatment process, the lighter the wood material 112 becomes. This is done to match the desired aesthetic of wood material 112 when finished with processing.

While the arrangement may be primarily shown and/or described with reference to treating wood material 112 using this example process, the embodiments are not so limited. Rather it is contemplated that in one or more arrangements the process for treatment of wood material 112 may include one or more additional processes or steps performed at various ones of the process blocks 10, 12, 14, 16, and/or 18. For example, in one or more arrangements, heat treatment and mechanical pressing of the wood at process blocks 12 and 14 may be applied in an enclosure. In one or more arrangements, environmental factors within such enclosure may be controlled and/or adjusted while treating the wood material 112. Controlled environmental factors within such enclosure may include but are not limited to, for example: temperature, humidity, atmospheric gases present, atmospheric pressure, application of chemicals and/or any other environmental factors.

In one or more arrangement shown, as one example, the method of treating wood material 112 is shown using a roll process, that is the wood is rolled across conveyor 102 as it is treated. In other arrangements, as examples, the wood material 112 may not be rolled as the wood material 112 is treated. Rather, the wood material 112 may be moved between stations which conduct of each the processes shown in process blocks 10, 12, 14, 16, and/or 18. That is, in one or more arrangements, the wood material 112 may be planed or otherwise prepared at one station, then transported to another station to perform another step, such as step 12, where the wood material 112 is heated. Then, the wood material 112 may be transported to another station to perform another step, such as step 14, where the wood material 112 is mechanically pressed. The wood material 112 may then be transported again to another station to perform another step, such as step 16, where the wood material 112 is cooled. Finally, the wood material 112 may be moved to yet another station to perform another step, such as step 18, for application of a sealant or other post treatment processing such as brushing.

### System 100:

In one or more arrangements a system for treating wood 100 (or simply system 100) is provided. System 100 is formed of any suitable size, shape, and design and is configured to treat a piece of wood material 112 through a treatment process as described herein. In the arrangement shown, as one example, system 100 includes a conveyor 102, a heating system 104, a mechanical press 106, and a cooling system 108, among other components.

### Conveyor 102:

Conveyor 102 may be formed of any suitable size, shape, and design and is configured to facilitate transportation of wood materials 112 for treatment. In the arrangement shown, conveyor 102 is a roller-type conveyer having a set of rollers 120 positioned along an elongated frame 122. However, the embodiments are not so limited. Rather it is contemplated that, in one or more arrangements, conveyor 102 may be any type of conveyor including but not limited to, for example: rollers, belts, drag chains, augers, and/or any other type of conveyor 102.

In this example arrangement, conveyor 102 extends a length from a source end 126 to a destination end 128. In the arrangement shown, as one example, conveyor 102 extends in approximate straight, horizontal, and level manner from source end 126 to destination end 128. However, the embodiments are not so limited. Rather, it is contemplated that, in one or more arrangements, conveyor 102, may be oriented to move wood material 112 horizontally, along sloped angles, along straight paths, through curves and/or corners, and/or any other shaped path.

### Frame 122:

Frame 122 is formed of any suitable size, shape, and design, and is configured to connect with and position rollers 120 along a path between source end 126 and destination end 128. In the arrangement shown, as one example, frame 122 includes a pair of siderails 130, legs 132, and crossbars 134, among other components.

Siderails 130:

Siderails 130 are formed of any suitable size, shape, and design, and are configured to connect with legs 132 and rollers 120. In the arrangement shown, as one example, siderails 130 extend in approximate parallel spaced relation to one another. In this example arrangement, siderails 130 each have a center member 138 having a generally planar shape extending between an upper end 140 and a lower end 142 from source end 126 to destination end 128. In this example arrangement, siderails 130 have a horizontal upper flange 144, extending outward from upper ends 140 of center member 138 of siderails 130, and a horizontal lower flange 146, extending outward from lower ends 142 of center member 138 of siderails 130.

In this example arrangement, siderails 130 have holes 150 in center member 138 to facilitate connection with rollers 120. In this example arrangement, siderails 130 also have holes 152 in lower flange 146 to facilitate connection with legs 132 and have holes 154 in upper flange 144 to facilitate connections, for example with mechanical press 106, heating system 104, cooling system 108, and/or other components of system 100.

In this example arrangement, siderails 130 are connected to legs 132, mechanical press 106, heating system 104, cooling system 108, and/or other components of system 100 by fasteners 156. In this example fasteners 156 are bolts extending through holes 150, 152, and 154. However, the embodiments are not so limited. Rather, it is contemplated that fasteners 156 may include any means or method for attachment of two components including but not limited to, for example, welding, rivets, pins, clamps, bolts, screws, adhesives, chemical bonding, and/or any other process or means that results in a permanent or semi-permanent connection.

Legs 132:

Legs 132 are formed of any suitable size, shape, and design, and are configured to hold siderails 130 and rollers 120 at an elevated position. In the arrangement shown, legs 132 have a generally elongated shape extending from upper ends 160, where legs 132 are connected to siderails 130, to lower ends 162.

Crossbars 134:

Crossbars 134 are formed of any suitable size, shape, and design, and are configured to provide structural support of frame 122 and stabilize legs 132. In the arrangement shown, crossbars 134 include a set of upper crossbars 166 that extend between respective pairs of the legs 132 proximate to the upper ends 160. In the arrangement shown, crossbars 134 also include a set of lower crossbars 168 that extend between respective pairs of the legs 132 proximate to the lower ends 162.

### Rollers 120:

Rollers 120 are formed of any suitable size, shape, and design and are configured to facilitate transportation of wood material 112 over rollers 120 along conveyor 102 from source end 126 to destination end 128. In the arrangement shown, rollers 120 each have an elongated cylindrical shaped body 172 extending between opposing ends 174 with a shaft 176 extending through a center axis of body 172 and outward from ends 174 of body 172. In this example arrangement, rollers 120 are positioned between siderails 130 with ends of shaft 176 held in place within holes 150 in center member 138 of siderails 130. Rollers 120 are configured to freely rotate about shaft 176 to facilitate movement of wood material 112 on top of rollers 120. In one or more arrangements, rollers 120 have bearings (not shown) to facilitate rotation of rollers 120 relative to shaft 176 and/or facilitate rotation of shaft 176 relative to siderails 130 with low friction.

In one or more arrangements, a pieces of wood material 112 may be manually moved along conveyor by a craftsperson to facilitate treatment of wood material 112 using heating system 104, mechanical press 106, and cooling system 108.

### Motorized Feed System 184:

Additionally or alternatively, in one or more arrangements, conveyor 102 may be a motorized conveyor system and/or may include a motorized feed system 184 configured to move pieces of wood material 112 along conveyor 102. Motorized feed system 184 is formed of any suitable size, shape, or design, and is configured to engage pieces of wood material 112 positioned on rollers 120 to move the pieces from source end 126 to destination end 128. In one or more arrangements, motorized feed system includes one or more rollers 186 positioned above rollers 120 and operably connected to a motor 190 configured to rotate rollers 186. In this example arrangement, motorized feed system 184 is configured to receive pieces of wood material 112 between roller 186 and rollers 120 and move the pieces of wood material 112 along conveyor 102 by rotation of rollers 186. In one or more arrangements, motor 190 may be configured to additionally or alternatively rotate roller 214 of mechanical press 106 to facilitate movement of pieces of wood material 112 along conveyor 102.

Motor 190 is formed of any suitable size, shape, and design and is configured to generate mechanical movement. In the arrangement shown, as one example, motor 190 is an electric motor (e.g., a DC motor or an AC motor) configured to convert electric power into rotational motion. However, embodiments are not so limited. For example, in some arrangements, motor 190 may be an internal combustion engine, a fluid driven engine (e.g., steam, water, and/or air driven), or any other type of motor or engine. In this example arrangement, motor 190 is operably connected to rollers 186 by a belt 192 extending between pullies (not shown) connected to an output shaft of motor 190 and rollers 186. In one or more arrangements, speed of motor 190 is adjustable to facilitate adjustment of the speed at which pieces of wood material 112 move along conveyor 102 and/or adjust the time which pieces of wood material 112 are treated, for example, by heating system 104, mechanical press 106, and cooling system 108.

In one or more arrangements, rollers 186 may be operably connected to conveyor 102 by a height adjustment assembly 198 configured to facilitate adjustment of the height at which rollers 186 are positioned above rollers 120, for example, to accommodate different thicknesses of pieces of wood material 112. In some arrangements, height adjustment assembly 198 may be configured to permit rollers 186 to automatically move upward to accommodate different thicknesses of pieces of wood material 112 while maintaining sufficient downward pressure on the pieces to move the pieces along conveyor 102 when rollers 186 are rotated.

### Heating System 104:

Heating System 104 is formed of any suitable size, shape, and design and is configured to apply heat to pieces of wood material 112 for treatment in order to char (i.e. carbonize) the surface of wood material 112. In the arrangement shown, as one example, heating system 104 includes an open flame torch 202 (e.g., a 400,000-600,000 BTU torch) configured to apply heat directly to pieces of wood material 112 for treatment. Alternatively, as one example, heating system 104 may include any number of open flame torches 202 (each of which may be, as one example, a 400,000-600,000 BTU torch). In the arrangement, as one example, the torch(es) 202 are placed at an angle, preferably between and including 30 and 45 degrees, however torch(es) 202 may be placed at any other angle, including any angle between and including 0 and 29 degrees and 46 and 180 degrees. While heating system 104 has been described according to the arrangement shown, as one example, the embodiments are not so limited. Rather, as previously described with reference to the example method shown in FIG. 1, it is contemplated that various different arrangements of heating system 104 may use various known methods or means including but not limited to fire (e.g., provided by torches and/or other open flame sources), electric heat elements, radiant heating elements heated air, and/or any other method of means for generating heat.

In this example arrangement, torch 202 is operably connected to held in place above rollers 120 of conveyor 102 by connection assembly 204. Connection assembly 204 is formed of any suitable size, shape, and design, and is configured to hold torch 202 (or other heating element) in place above conveyor 102 to facilitate application of heat to pieces of wood material 112 to be treated.

In the arrangement shown, as one example, connection assembly 204 is an arm extending from a first end 206, where connection assembly 204 is connected to upper flange 144, to a second end 208, where connection assembly 204 is connected to torch 202. In this example arrangement, connection assembly 204 positions torch 202 so flame produced by torch 202 contacts and heats pieces of wood material 112 before, during, and/or after such pieces are pressed by mechanical press 106. In one or more arrangements, connection assembly 204 may position torch 202 to additionally or alternatively heat mechanical press 106 or other conductive element to transfer heat to pieces of wood material 112 indirectly.

### Mechanical Press 106:

Mechanical press 106 is formed of any suitable size, shape, and design and is configured to apply a compressive force to pieces of wood material 112 before, during, or after the application of heat by heating system 104.

In the arrangement shown, as one example, mechanical press 106 includes a roller 214 mounted over one or more of the rollers 120 by a bracket assembly 216. In this example arrangement, mechanical press 106 is configured to receive pieces of wood material 112 between roller 214 and the roller 120 and compress pieces of wood material 112 between roller 214 and the one or more rollers 120.

### Roller 214:

Roller 214 is formed of any suitable size, shape, are design and is configured to compress pieces of wood between roller 214 and one or more rollers 120 positioned below roller 214. In the arrangement shown, roller 214 has an elongated cylindrical shaped body 218 extending between opposing ends 220 with a shaft 222 extending through a center axis of body 218 and outward from ends 220 of body 218.

In one or more arrangements, body 218 of roller 214 has patterned exterior surface 226. Patterned exterior surface 226 may be formed of any suitable size, shape, and design, and is configured to form a desired pattern or texture on in a piece of wood material 112 when the piece of wood material 112 is compressed by roller 214. In one or more arrangements, as examples, the patterned exterior surface 226 is formed of protrusions 228 which are less than or equal to one-eighth inch in depth and/or width, however in other arrangements, as examples, the protrusions 228 of patterned exterior surface 226 may exceed one-eighth inch in depth and/or width.

In the arrangement shown, as one example, patterned exterior surface 226 has protrusions 228 having a honeycomb pattern shape. However, the arrangement are not so limited. Rather it is contemplated that patterned exterior surface 226 may include protrusions, recesses, textures and/or other structure in any pattern or arrangement including but not limited to, for example, honeycomb, circles, triangles, squares, other polygon shapes, lines, chevron, houndstooth, undulating pattern, and/or any other shape and/or pattern. In one or more arrangements, the pattern is uniform. In one or more arrangements, the pattern is non-uniform

In the arrangement shown, roller 214 is configured to freely rotate about shaft 222 to facilitate movement of wood material 112 between roller 214 and one or more rollers 120 below roller 214. In the arrangement shown, bearings 230 are positioned on end shaft 222 to facilitate rotation of shaft 222 relative to bracket assembly 216. Additionally or alternatively, in one or more arrangements, roller 214 has bearings (not shown) positioned to facilitate rotation of roller 214 relative to shaft 222.

In the arrangement shown, as one example, roller 214 applies pressure to a piece of wood material 112 as the piece of wood material 112 is moved along conveyor 102. While mechanical press 106 has been shown and described according to example arrangements as having roller 214, mechanical press 106 is not so limited. Rather, mechanical press 106 may apply a downward force to the top of all or a portion of one or more pieces of wood material 112 at the same time. In this alternative arrangement, as one example, mechanical press 106 may include a plate, stamp, or other mechanism with a surface capable of applying downward force to an area, which is designed to press down on all or a portion of the top surface of one or more pieces of wood material 112, pressing the piece or pieces of wood material 112.

### Bracket Assembly 216:

Bracket assembly 216 is formed of any suitable size, shape, and design, and is configured to operably connect roller 214 to conveyor 102 and hold roller 214 in position to facilitate mechanical pressing of pieces of wood material 112. In the arrangement shown, as one example, bracket assembly 216 includes a pair of mounting members 236, an arm 238 connected to and extending between mounting members 236, and flanges 240 and 242 extending rearward from arm 238 on opposing sides of roller 214, among other components.

### Mounting Members 236:

In this example arrangement, mounting members 236 have a generally rectangular planar shape having a top 248, a bottom 250, and sides 252 extending between a forward end 254 and a rearward end 256. In this example arrangement, mounting member 236 have holes 258 extending to facilitate connection of bracket assembly 216 to upper flange 144 of siderails 130 of frame 122 by fasteners 156.

### Arm 238:

In this example arrangement, arm 238 is connected to top 248 of mounting members 236. In this example arrangement, arm 238 is a planar rectangular shape having a front surface 262 and rear surface 264, extending between a top edge 266, a bottom edge 268, and opposing side edges 270.

### Flanges 240 and 242:

In this example arrangement, flanges 240 and 242 extending rearward from arm 238 to facilitate connection with shaft 222 of roller 214 of mechanical press 106. In one or more arrangements, flange 240 is a stationary flange connected to arm 238. In this example arrangement, flange 240 has a generally rectangular planar shape having side surfaces 276 extending between a top edge 278, a bottom edge 280, a rear edge 282, a front edge 284, where flange 240 is connected to arm 238. In this example arrangement, flange 240 has a hole 286 proximate to rearward edge 282 to facilitate connection with shaft 222 of roller 214 of mechanical press 106 (e.g., using a fastener 156).

In one or more arrangements, flange 242 is movable along arm 238 (or removeable from arm 238) to facilitate installation of shaft 222 and roller 214 of mechanical press 106 between flanges 240 and 242. Similar to flange 240, flange 242 has a generally rectangular planar shape having side surfaces 292 extending between a top edge 294, a bottom edge 296, a rear edge 298, and a front edge 300. In this example arrangement, flange 242 has a hole 302 proximate to rearward edge 298 to facilitate connection with shaft 222 of roller 214 of mechanical press 106 (e.g., using a fastener 156). In this example arrangement, bearings 230 are positioned within holes 286 and 302 to facilitate smooth rotation of shaft 222 and roller 214 of mechanical press 106.

In this example arrangement, flange 242 includes a rectangular shaped collar 306 connected to front edge 300 of flange 242 and extending around arm 238. Collar 306 is movable along arm 238 to facilitate repositioning of flange 242. In this example arrangement, collar 306 has a hole 308 positioned on a forward side of collar 306 to facilitate connection of collar 306 and flange 242 with arm 238 (e.g., using a fastener 156). In this example arrangement, collar 306 may be connected and fixed in position along arm 238 using a bolt type fastener that extends through hole 308 and engages arm 238 and clamps collar 306 and flange 24 in place when rotated. However, it is contemplated that any type of fastener may be used in one or more arrangements.

In one or more arrangements, bracket assembly 216 is configured to facilitate adjustment of the height of roller 214 of mechanical press 106 relative to rollers 120 to accommodate different thicknesses of pieces wood material 112. In some arrangements, bracket assembly 216 may be configured to permit roller 214 to automatically move upward to accommodate different thicknesses of pieces of wood material 112 while maintaining sufficient downward pressure on the pieces to compress and/or emboss a piece of wood material 112 with a pattern. For example, in one or more arrangements, mounting members 236 of bracket assembly 216 are configured move up and down along fasteners 156 positioned within holes 258 of mounting members 236.

### Bias Member 244:

In one or more arrangements, bracket assembly 216 includes a bias member 244. Bias member 244 is formed of any suitable size, shape, and design and is configured to apply downward force sufficient to move bracket assembly 216 and roller 214 downward in absence of an opposing force, and thereby compress and/or emboss a piece of wood material 112 with a pattern.

As one illustrative example, in one or more arrangements, bias member 244 includes springs connected between mounting members 236 of bracket assembly 216 and frame 122, which are configured to pull mounting members 236 downward. Additionally or alternatively, in one or more arrangements, bias member 244 may be, or may be positioned on, fasteners above mounting members 236 which apply a downward force to mounting members 236. However, the arrangements are not so limited to these example implementations. Rather, it is contemplated that in some various arrangements, bias member 244 may utilize various mechanisms to apply a biasing force including but not limited to, for example, springs, gas pistons, gas springs, hydraulic pistons, actuators, solenoids, pneumatic members, weights, and/or any other force generating means or combination thereof.

### Cooling System 108:

In some arrangements, system 100 includes a cooling system 108. Cooling System 108 is formed of any suitable size, shape, and design, and is configured to cool pieces of wood material 112 after heating and before, during, or after pressing and/or inhibit such pieces of wood material 112 from catching on fire.

In the arrangement shown, as one example, cooling system 108 includes a sprayer 320 configured to spray the wood material 112 with water and/or other liquid coolant. However, the embodiments are not so limited. Rather, it is contemplated that various different arrangements may cool the wood using various known methods or means including but not limited to, for example, spraying with water and/or liquid coolant, bath in water and/or liquid coolant, cooling in the ambient environment, fans, chilled air, transfer of heat from the wood to a heat sink or other object via conduction and/or any other method of means for cooling.

### Sprayer 320:

In this example arrangement, sprayer 320 is operably connected to and held in place above rollers 120 of conveyor 102 by connection assembly 322. Connection assembly 322 is formed of any suitable size, shape, and design, and is configured to hold sprayer 320 (or other cooling element) in place above conveyor 102 to facilitate cooling of pieces of wood material 112.

### Connection Assembly 322

In the arrangement shown, as one example, connection assembly 322 is an arm extending upwards from a first end 324, where connection assembly 322 is connected to upper flange 144, to a second end 326, where connection assembly 322 is connected to sprayer 320. In this example arrangement, connection assembly 322 positions sprayer 320 so pieces of wood material 112 are sufficiently cooled after heating and pressing. However, in alternative arrangements, as examples, cooling system 108 and spray 320 may be positioned to cool before or during pressing as well.

### Control System 400:

In one or more arrangements, system 100 includes a control system 400. Control system 400 is formed of any suitable size, shape, and design and is configured to control operation of conveyor 102, motorized feed system 184, heating system 104, mechanical press 106, cooling system 108 and/or other components of system 100 to facilitate treatment of wood materials 112. In the arrangement shown, as one example, control system 400 includes a control circuit 402, user interface 404, and/or sensors 406, among other components.

### Control Circuit 402:

Control circuit 402 is formed of any suitable size, shape, design and is configured to control operation of conveyor 102, motorized feed system 184, heating system 104, mechanical press 106, cooling system 108 and/or other components of system 100 to facilitate treatment of wood materials 112 in response to signals of sensors 406 and/or input from user interface 404. In the arrangement shown, as one example implementation, control circuit 402 includes a communication circuit 410, a processing circuit 412, and a memory 414 having software code 416 or instructions that facilitates the operation of system 100.

### Processing Circuit 412:

Processing circuit 412 may be any computing device that receives and processes information and outputs commands according to software code 416 stored in memory 414. For example, in some various arrangements, processing circuit 412 may be discreet logic circuits or programmable logic circuits configured for implementing these operations/activities, as shown in the figures and/or described in the specification. In certain arrangements, such a programmable circuit may include one or more programmable integrated circuits (e.g., field programmable gate arrays and/or programmable ICs). Additionally or alternatively, such a programmable circuit may include one or more processing circuits (e.g., a computer, microcontroller, system-on-chip, smart phone, server, and/or cloud computing resources). For instance, computer processing circuits may be programmed to execute a set (or sets) of software code stored in and accessible from memory 414.

### Memory 414:

Memory 414 may be any form of information storage such as flash memory, ram memory, dram memory, a hard drive, or any other form of memory. Processing circuit 412 and memory 414 may be formed of a single combined unit. Alternatively, processing circuit 41 and memory 414 may be formed of separate but electrically connected components. Alternatively, processing circuit 412 and memory 414 may each be formed of multiple separate but communicatively connected components.

Software code 416 is any form of instructions or rules that direct processing circuit 412 how to receive, interpret and respond to information to operate as described herein. Software code 416 or instructions is stored in memory 414 and accessible to processing circuit 412. As an illustrative example, in one or more arrangements, software code 416 or instructions may configure processing circuit 412 to monitor sensors 406 to facilitate control of various components of system 100.

As some illustrative examples, in one or more arrangements, control system 400 is configured to control speed at which pieces of wood material 112 are moved along conveyor 102 (thereby affecting the amount of charring or carbonizing of the surface of wood material 112), temperature and/or duration of heat treatment applied by heating system 104 (thereby affecting the amount of charring or carbonizing of the surface of wood material 112), the angle at which heat treatment is being applied by heating system 104 relative to wood material 112 or the direct or indirect contact of the flame produced by torch(es) 202 (thereby affecting the amount of charring or carbonizing of the surface of wood material 112), the amount of pressure applied by mechanical press 106, temperature and/or duration of cooling applied by cooling system, and/or environmental conditions in which wood materials 112 are treated (e.g., atmospheric gases, humidity, temperature, etc.), monitoring operation of system 100, detecting accidental fire, triggering fire suppression systems (e.g., sprinklers); sounding an alarm, alerting fire department, transmitting, communicating status alerts staff (e.g., via automated call, SMS, push notification, email, messaging on social networks, or any other means or methods for messaging). In one or more arrangements, operation of control circuit 402 is configurable by a user via user interface 404 to customize/adjust operation of system 100.

### Communication Circuit 410:

Communication circuit 410 is formed of any suitable size, shape, design, technology, and in any arrangement and is configured to facilitate communication with devices to be controlled, monitored, and/or alerted by control system 400. In one or more arrangements, as one example, communication circuit 410 includes a transmitter (for one-way communication) or transceiver (for two-way communication). In various arrangements, communication circuit 410 may be configured to communicate with various components of system 100 using various wired and/or wireless communication technologies and protocols over various networks and/or mediums including but not limited to, for example, Serial Data Interface 12 (SDI-12), UART, Serial Peripheral Interface, PCI/PCIe, Serial ATA, ARM Advanced Microcontroller Bus Architecture (AMBA), USB, Firewire, RFID, Near Field Communication (NFC), infrared and optical communication, 802.3/Ethernet, 802.11/WIFI, Wi-Max, Bluetooth, Bluetooth low energy, UltraWideband (UWB), 802.15.4/ZigBee, ZWave, GSM/EDGE, UMTS/HSPA+/HSDPA, CDMA, LITE FM/VHF/UHF networks, and/or any other communication protocol, technology or network.

### Sensors 406:

Sensors 406 are formed of any suitable size, shape, design, technology, and in any arrangement configured to provide information relevant to the treatment of wood materials 112. In some various arrangements, sensors 406 may include but are not limited to, for example, temperature sensors, chemical sensors, humidity sensors, positional sensors, and/or any other type of sensor. In some arrangements, sensors 406 may be formed along with control circuit 402 as a single combined unit. Alternatively, in some arrangement sensors 406 and control circuit 402 may be communicatively connected by communication circuit 410.

### User Interface 404:

User interface is formed of any suitable size, shape, design, technology, and in any arrangement, and is configured to facilitate user control and/or adjustment of various components of system 100. In one or more arrangements, as one example, user interface 404 includes a set of inputs (not shown). Inputs are formed of any suitable size, shape, and design and are configured to facilitate user input of data and/or control commands. In various different arrangements, inputs may include various types of controls including but not limited to, for example, buttons, switches, dials, knobs, a keyboard, a mouse, a touch pad, a touchscreen, a joystick, a roller ball, or any other form of user input. Optionally, in one or more arrangements, user interface 404 includes a display not shown). Display is formed of any suitable size, shape, design, technology, and in any arrangement, and is configured to facilitate display information of settings, sensor readings, time elapsed, and/or other information pertaining to treatment of wood materials 112 by system 100. In one or more arrangements, display may include, for example, LED lights, meters, gauges, screen or monitor of a computing device, tablet, and/or smartphone. Additionally or alternatively, in one or more arrangements, the inputs and/or display may be implemented on a separate device that is communicatively connected to control circuit 402. For example, in one or more arrangements, operation of control circuit 402 may customized using a smartphone or other computing device that is communicatively connected to the control circuit 402 (e.g., via Bluetooth, WIFI, and/or the internet).

### Decorative Wood Piece:

They system and method presented herein are configured to produce decorative wood pieces. In the arrangement shown, as one example, wood material 112 is processed using the system and method presented herein, as examples. The end result is a decorative wood piece made from wood material 112. The decorative wood piece has surfaces including an upper side, a lower side, a first end, a second end, a first side, and a second side. In the arrangement shown, as one example, the decorative wood piece extends a height between the upper side and the lower side, a length between the first end and the second end, and a width between the first side and the second side. At least one surface of the decorative wood piece will be charred, or carbonized, from the heat produced by heating system 104. At least one surface of the decorative wood piece will also have a pattern formed into the surface while the wood material 112 is being placed under pressure by the mechanical press 106 having a pattern, such as the protrusions 228 of roller 214, or other protrusions or recesses of roller 214 or a plate or other mechanism used as part of mechanical press 106. The pattern on the decorative wood piece may be any number of patterns, including but not limited to, honeycomb, circles, triangles, squares, other polygon shapes, lines, chevron, houndstooth, undulating pattern, and/or any other shape and/or pattern.

In one or more arrangements of decorative wood pieces, any combination and number of surfaces may be charred and may have patterns. That is, in one arrangement, as one example, only one surface of the decorative wood piece is charred and has a patter. In an alternative arrangement, as another example, each of the surfaces may be charred and may have patterns. In yet another example, one surface may be charred and another surface may have a pattern formed on it. These, as well as any other combination may be present on a decorative wood piece without departing from scope of the invention presented herein.

Once the wood material 112 has been charred by heating system 104 and a pattern has been pressed onto wood material 112 using mechanical press 106, the decorative wood piece is then brushed in order to reduce the among of charring on the surface and also lighten the color of the decorative wood piece to the desired color. After brushing, the decorative wood piece can be sealed using a sealant in order to get the desired dullness or shininess of the decorative wood piece.

From the above discussion it will be appreciated that one or more arrangements presented herein improve upon the state of the art and provide a method and/or system for treatment of wood: that quickly and effectively treats wood; that controls cracking; that cures and increases longevity of wood; that does not require a lengthy drying time; that does not use chemicals; that is streamlined; that can be implemented in a production line; that is relatively inexpensive; that does not use chemicals; that is easy to use; that is easy to control; that has a long useful life; that is durable; that has a robust design; that is easy to install; that increases design options and/or that is high quality. These and other objects, features, or advantages of the disclosure will become apparent from the specification, figures, and claims.

Although the present disclosure has been described with respect to certain illustrative embodiments, those skilled in the art will appreciate it is not limited to these embodiments and that changes and modifications can be made therein within the scope of the disclosure as set forth in the appended claims.

What is claimed:

1. A method of forming a charred surface on wood material by treating the wood material, the method comprising:
applying heat to the wood material;
wherein applying heat to the wood material forms the charred surface on the wood material;
applying pressure to the wood material;
spraying water and/or coolant onto the wood material in order to cool the wood material;
brushing the charred surface of the wood material; and
wherein brushing the charred surface causes the wood material to appear lighter in color and the more charred material that is brushed off the wood material, the lighter the wood material becomes.

2. The method of claim 1, further comprising:
transporting the wood material along a conveyor from a source end to a destination end;
wherein the applying of heat is performed as the wood material is transported from the source end to the destination end;
wherein the applying of pressure is performed as the wood material is transported from the source end to the destination end.

3. The method of claim 1, further comprising:
applying a sealant to the wood material following brushing of the wood material;
wherein the sealant affects the dullness or shininess of the wood material.

4. The method of claim 1, wherein the applying of pressure to the wood material forms a pattern on the wood material.

5. The method of claim 1, wherein the pressure is applied to the wood material by a mechanical press.

6. The method of claim 1, wherein the applying of pressure is performed using a mechanical press having a roller.

7. The method of claim 1, wherein the applying of heat includes heating the wood material using a torch.

8. A system for treating wood material in order to form a charred surface on the wood material, the system comprising:
a heating system;
the heating system configured to apply heat to the wood material;
a mechanical press;
the mechanical press configured to apply pressure to the wood material;
a cooling system;
the cooling system configured to cool the wood material; and
wherein when the wood material is cooled, the charred surface of the wood material is brushed which causes the wood material to appear lighter in color and the more charred material that is brushed off the wood material, the lighter the wood material becomes.

9. The system of claim 8, further comprising:
a conveyor;
the conveyor configured to transport the wood material from a source end to a destination end;
wherein the heating system is operably connected to the conveyer and is configured to apply the heat to the wood material as it is transported from the source end to the destination end;
wherein the mechanical press is operably connected to the conveyer and is configured to apply the pressure to the wood material as it is transported from the source end to the destination end.

10. The system of claim 8, further comprising:
a conveyor;
the conveyor having a set of rollers;
the conveyor configured to transport the wood material on the set of rollers from a source end to a destination end;
wherein the heating system is operably connected to the conveyer and is configured to apply the heat to the wood material as it is transported from the source end to the destination end;
wherein the mechanical press is operably connected to the conveyer and is configured to apply the pressure to the wood material as it is transported from the source end to the destination end after heat is applied by the heating system.

11. The system of claim 8, wherein the mechanical press is configured to form a pattern on the charred surface of the wood material.

12. The system of claim 8, wherein the mechanical press is a roller having a pattern formed on an exterior surface of the roller.

13. The system of claim 8, wherein the mechanical press is a roller having a pattern formed on an exterior surface of the roller;
wherein the pattern is formed by protrusions on the exterior surface.

14. The system of claim 8, wherein the mechanical press is a roller having a pattern formed on an exterior surface of the roller;
wherein the pattern is formed by recesses on the exterior surface.

15. The system of claim 8, wherein the cooling system includes a sprayer configured to apply a water and/or coolant to the wood material.

16. The system of claim 8, wherein the heating system is a torch.

17. The system of claim 8, wherein the heating system is an electric heating element.

18. The system of claim 8, wherein the heating system is a radiant heating element.

19. The system of claim 8, wherein the heating system is configured to apply heat indirectly to the wood material.

20. A decorative wood piece, comprising:
a decorative wood piece;
the decorative wood piece extending a height between an upper surface and a lower surface;
the decorative wood piece extending a length between a first end and a second end;
the decorative wood piece extending a width between a first side and a second side;
wherein the upper surface is charred by a burning process;
wherein the upper surface includes a pattern that is formed into the upper surface of the wood piece under pressure with a mechanical press having a pattern therein;
wherein the exterior surface is sealed using a sealant.

21. The decorative wood piece of claim 20, wherein the mechanical press applies pressure to the decorative wood piece.

22. The decorative wood piece of claim 20, wherein the mechanical press includes a roller and the roller applies pressure to the decorative wood piece.

23. The decorative wood piece of claim 20, wherein the mechanical press includes a plate and the plate applies pressure to the decorative wood piece.

24. The decorative wood piece of claim 20, wherein the burning process includes heating the decorative wood piece using a torch.

25. The decorative wood piece of claim 20, wherein the burning process includes heating the decorative wood piece using an electric heating element.

26. The decorative wood piece of claim 20, wherein the burning process includes heating the decorative wood piece using a radiant heating element.

27. The decorative wood piece of claim 20, wherein the burning process includes heating the decorative wood piece indirectly.

28. The decorative wood piece of claim 20, wherein the pattern formed into the upper surface of the decorative wood piece is a honeycomb pattern.

29. The decorative wood piece of claim 20, wherein the pattern formed into the upper surface of the decorative wood piece is a circle pattern.

30. The decorative wood piece of claim 20, wherein the pattern formed into the upper surface of the decorative wood piece is a lined pattern.

31. The decorative wood piece of claim 20, wherein the pattern formed into the upper surface of the decorative wood piece is a houndstooth pattern.

32. The decorative wood piece of claim 20, wherein the pattern formed into the upper surface of the decorative wood piece is a chevron pattern.

33. The decorative wood piece of claim 20, wherein the pattern formed into the upper surface of the decorative wood piece is an undulating pattern.

34. The decorative wood piece of claim 20, wherein the charred upper surface is brushed to produce a lighter color of the decorative wood piece.
